(19) United States
(12) Patent Application Publication
(10) Pub. No.: US 2026/0371353 A1
(43) Pub. Date: Nov. 19, 2026

(54) BLIND DETECTION METHOD FOR DOWNLINK CONTROL INFORMATION, METHOD FOR PROCESSING DOWNLINK CONTROL INFORMATION, DEVICE, AND MEDIUM

(71) Applicant: Beijing Xiaomi Mobile Software Co., Ltd., Beijing (CN)

(72) Inventors: Shijuan WU, Beijing (CN); Lei WANG, Beijing (CN)

(73) Assignee: Beijing Xiaomi Mobile Software Co., Ltd., Beijing (CN)

(21) Appl. No.: 19/157,058

(22) PCT Filed: Feb. 17, 2023
(86) PCT No.: PCT/CN2023/076967

§ 371 Date: Aug. 15, 2025

(51) Int. Cl. H04W 72/231; H04W 72/1263

(52) U.S. Cl. CPC H04W 72/231; H04W 72/1263

(57) ABSTRACT

A blind detection method for downlink control information, includes: determining a first size of the downlink control information, according to a size of an information field in downlink control information configured for scheduling a plurality of cells; determining a second size of received downlink control information according to indication information; and performing blind detection on the received downlink control information, according to a relationship between the first size and the second size wherein a size of the downlink control information for the blind detection is equal to the second size.

### CROSS-REFERENCE TO RELATED APPLICATIONS

The present application is a U.S. National Stage of International Application No. PCT/CN2023/076967, filed on Feb. 17, 2023, the contents of all of which are incorporated herein by reference in their entirety for all purposes.

### BACKGROUND OF THE DISCLOSURE

In the related art, scheduling one downlink control information (DCI) in a cell simply allows to schedule data of one cell, such as scheduling a physical uplink shared channel (PUSCH) or a physical downlink shared channel (PDSCH). However, as frequency resources become increasingly fragmented, the demand for scheduling data from a plurality of cells simultaneously is gradually increasing.

### SUMMARY OF THE PRESENT DISCLOSURE

The present disclosure relates to the field of a communication technology, and in particular to a blind detection method for downlink control information, a method for processing downlink control information, a communication device, and a non-transitory computer-readable storage medium.

According to a first aspect of the embodiments of the present disclosure, a blind detection method for downlink control information is provided. The method is performed by a terminal and includes: determining a first size of the downlink control information, according to a size of an information field in downlink control information configured for scheduling a plurality of cells; determining a second size of the received downlink control information according to indication information; and performing blind detection on the received downlink control information, according to a relationship between the first size and the second size, where a size of the downlink control information for the blind detection is equal to the second size.

According to a second aspect of the embodiments of the present disclosure, a method for processing downlink control information is provided. The method is performed by a network device and includes: determining a first size of the downlink control information, according to a size of an information field in downlink control information configured for scheduling a plurality of cells; sending indication information to a terminal, where the indication information is configured to indicate a second size of the downlink control information sent to the terminal; and processing the downlink control information sent to the terminal, according to a relationship between the first size and the second size, where a size of the processed downlink control information is equal to the second size.

According to a third aspect of the embodiments of the present disclosure, a communication device is provided. The communication device includes: one or more processors; and a memory that stores a computer program, where the computer program, when collectively executed by one or more processors, causes the communication device to:
determine a first size of the downlink control information, according to a size of an information field in downlink control information configured for scheduling a plurality of cells;
determine a second size of received downlink control information according to indication information; and
perform blind detection on the received downlink control information, according to a relationship between the first size and the second size, wherein a size of the downlink control information for the blind detection is equal to the second size.

According to a fourth aspect of the embodiments of the present disclosure, a non-transitory computer-readable storage medium storing a computer program is provided. The computer program, when collectively executed by one or more processors, causes the one or more processors to perform the above blind detection method for the downlink control information.

### BRIEF DESCRIPTION OF DRAWINGS

To more clearly illustrate the technical solutions in the embodiments of the present disclosure, the accompanying drawings needed to be used in the description of the embodiments will be briefly introduced below. Apparently, the accompanying drawings described below are merely some embodiments of the present disclosure. For one having ordinary skill in the art, other accompanying drawings can be obtained based on these accompanying drawings without any creative effort.

FIG. 1 is a schematic flowchart of a blind detection method for downlink control information according to an embodiment of the present disclosure.

FIG. 2 is a schematic flowchart of a blind detection method for downlink control information according to another embodiment of the present disclosure.

FIG. 3 is a schematic flowchart of a blind detection method for downlink control information according to yet another embodiment of the present disclosure.

FIG. 4 is a schematic flowchart of a blind detection method for downlink control information according to yet another embodiment of the present disclosure.

FIG. 5 is a schematic flowchart of a blind detection method for downlink control information according to yet another embodiment of the present disclosure.

FIG. 6 is a schematic flowchart of a blind detection method for downlink control information according to yet another embodiment of the present disclosure.

FIG. 7 is a schematic flowchart of a blind detection method for downlink control information according to yet another embodiment of the present disclosure.

FIG. 8 is a schematic flowchart of a method for processing downlink control information according to an embodiment of the present disclosure.

FIG. 9 is a schematic diagram showing interaction between a terminal and a network device according to an embodiment of the present disclosure.

FIG. 10 is a schematic block diagram of a blind detection device for downlink control information according to an embodiment of the present disclosure.

FIG. 11 is a schematic block diagram of a device for processing downlink control information according to an embodiment of the present disclosure.

FIG. 12 is a schematic block diagram of a device for processing downlink control information according to an embodiment of the present disclosure.

FIG. 13 is a schematic block diagram of a blind detection device for downlink control information according to an embodiment of the present disclosure.

### DETAILED DESCRIPTION OF THE PRESENT DISCLOSURE

The technical solutions in the embodiments of the present disclosure will be clearly and completely described below in conjunction with the accompanying drawings in the embodiments of the present disclosure. Apparently, the described embodiments are merely part of the embodiments of the present disclosure, rather than all embodiments. Based on the embodiments in the present disclosure, all other embodiments obtained by one having ordinary skill in the art without any creative effort will fall within the protection scope of the present disclosure.

The terms used in the embodiments of the present disclosure are for the purpose of describing specific embodiments simply and are not intended to limit the embodiments of the present disclosure. As used in the embodiments of the present disclosure and the appended claims, the singular forms “a/an” and “the” are intended to include the plural forms as well, unless the context clearly indicates otherwise. It is also to be understood that the term “and/or” used here refers to and encompasses any and all possible combinations of one or more of the associated items listed.

It is to be understood that although the terms such as first, second, and third may be used to describe various information in the embodiments of the present disclosure, the information is not going to be limited to these terms. These terms are used to distinguish information of the same type from one another. For example, without departing from the scope of the embodiments of the present disclosure, first information may also be referred to as second information, and similarly, the second information may also be referred to as the first information. The word “if” as used here may be interpreted as “in a case where” or “upon” or “in response to determining”, depending on the context.

For the purpose of brevity and ease of understanding, the terms “greater than” or “less than” and “higher than” or “lower than” are used here to represent size relationships. However, it can be understood by one having skill in the art that the term “greater than” also covers the meaning of “greater than or equal to”, “less than” also covers the meaning of “less than or equal to”, “higher than” covers the meaning of “higher than or equal to” and “lower than” also covers the meaning of “lower than or equal to”.

In one embodiment, a network device may send to the terminal downlink control information configured for scheduling a plurality of cells. The downlink control information configured for scheduling the plurality of cells may also be referred to as multi-cell scheduling downlink control information, for example, may be written as multi-cell scheduling DCI, which may be abbreviated as MC-DCI. For the convenience of examples below, part of the downlink control information configured for scheduling the plurality of cells will be referred to as MC-DCI.

The MC-DCI may be configured for scheduling the plurality of cells, specifically referring to data configured for scheduling the plurality of cells, such as a PUSCH, a PDSCH, etc., for scheduling one or more cells among the plurality of cells. In this way, the plurality of cells can be scheduled via one downlink control information.

In one embodiment, the MC-DCI may be scrambled by a cell radio network temporary identifier (C-RNTI) or may be scrambled by other RNTIs, such as a newly defined RNTI. In this regard, the C-RNTI may be chosen as needed and is not limited to the present disclosure.

In one embodiment, the MC-DCI may include an MC-DCI configured for scheduling uplink transmission of the plurality of cells. For example, a format may be denoted as DCI format 0_X. The MC-DCI may also include an MC-DCI configured for scheduling downlink transmission of the plurality of cells. For example, the format may be denoted as DCI format 1_X, where X may be, for example, 3.

The MC-DCI in the subsequent embodiments may include the MC-DCI configured for scheduling uplink transmission of the plurality of cells, the MC-DCI configured for scheduling downlink transmission of the plurality of cells, or the MC-DCI configured for scheduling uplink transmission of the plurality of cells and the MC-DCI configured for scheduling downlink transmission of the plurality of cells.

Since this embodiment introduces the MD-DCI based on legacy DCI, this may result in an increase in the number of DCI sizes, where the size refers to the number of bits occupied and can be understood as dimension or magnitude.

A large number of DCI sizes will increase the complexity of blind detection for DCI by the terminal. In this regard, the network device may align the DCI sizes to be sent, reducing the number of DCI sizes, which enables the number of DCI sizes to meet the DCI size budget. Blind detection can be referred to as blind decoding or blind monitoring. It may be a process where a UE, after determining a search space type of a physical downlink control channel, repeatedly decodes or monitors a candidate resource set without being able to clearly identify a time-frequency position of the PDCCH.

The alignment process includes at least one of the following: aligning the legacy DCI, aligning the MC-DCI with the legacy DCI, or aligning the MC-DCI configured for scheduling uplink transmission of the plurality of cells with the MC-DCI configured for scheduling downlink transmission of the plurality of cells.

It is to be noted that in the embodiments of the present disclosure, after the network device aligns the DCI sizes, the number of DCI sizes may meet a “k+1” condition, meaning that in one cell, the number of DCI sizes is less than or equal to k+1, where the number of DCI sizes scrambled by the C-RNTI is less than or equal to k. The value of k can be set as needed, for example, it may be 3 or 4.

In one embodiment, the MC-DCI may include at least one information field, where the information field may also be referred to as a field for short.

In one embodiment, the terminal may determine a first size of the MC-DCI according to a size of an information field in the MC-DCI. For example, the first size may be determined to be equal to the sum of sizes of all information fields in the MC-DCI.

The size of the information field in the MC-DCI may be determined based on a protocol agreement, or may be determined according to configuration information of the network device. For example, the size of each of the information fields may be determined based on a mechanism in the related art, which will not be further elaborated in the present disclosure.

In one embodiment, before or during the process of sending the MC-DCI to the terminal, the network device may send indication information to the terminal. The indication information indicates a second size of the MC-DCI sent to the terminal.

The first size may be understood as a preset size of the MC-DCI, and the second size is an actual size of the MC-DCI sent by the network device to the terminal.

Since the network device will align the sizes of the DCI, a change in the first size may occur in a case where the alignment process involves aligning the MC-DCI, and the changed first size becomes the second size. As a result, aligning the sizes of the DCI by the network device may cause a difference between the first size and the second size. The difference between the first size and the second may give rise to some problems. For example, the terminal performs the blind detection on the MC-DCI according to the second size and does not know the size of each information field in the MC-DCI in a case where the size of the MC-DCI is the second size, leading to errors in the blind detection process and damaging the scheduling performance of the MC DCI.

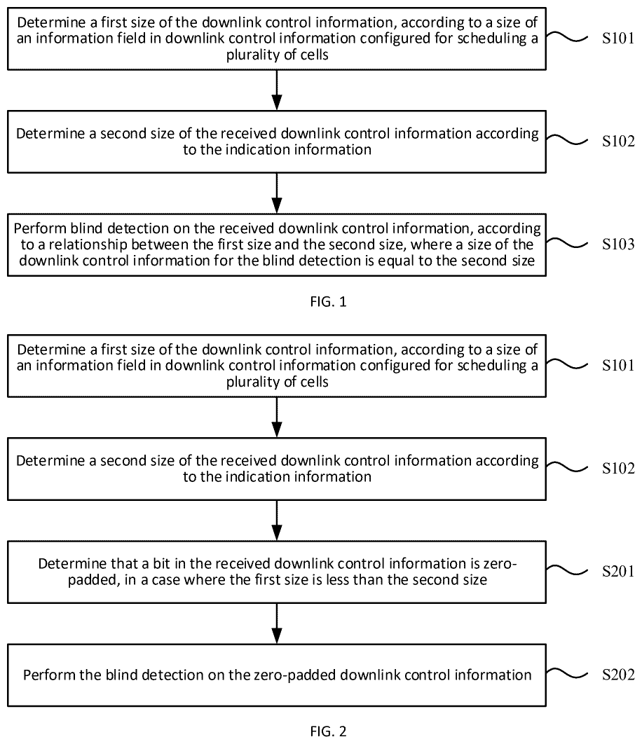

FIG. 1 is a schematic flowchart of a blind detection method for downlink control information according to an embodiment of the present disclosure. The blind detection method for the downlink control information shown in this embodiment may be performed by a terminal. The terminal includes, but is not limited to, a mobile phone, a tablet computer, a wearable device, a sensor, an Internet of Things device, or other communication devices. The terminal may communicate with a network device. The network device includes, but is not limited to, a network device in 4G, 5G, 6G, or other communication systems, such as a base station and a core network.

As shown in FIG. 1, the blind detection method for the downlink control information may include the following steps S101-S103.

In step S101, a first size of the downlink control information is determined, according to a size of an information field in downlink control information configured for scheduling a plurality of cells;

In step S102, a second size of received downlink control information is determined according to the indication information.

In step S103, blind detection is performed on the received downlink control information, according to a relationship between the first size and the second size, where a size of the control information for the blind detection is equal to the second size.

In one embodiment, the terminal may determine the first size of the MC-DCI according to the size of an information field in the MC-DCI. For example, the first size is determined to be equal to the sum of sizes of all information fields in the MC-DCI. The terminal may also determine the second size of the received MC-DCI according to the indication information.

In one embodiment, the indication information may come from a scheduling cell. The scheduling cell refers to a cell where the terminal is camped on when receiving the MC-DCI.

In one embodiment, the indication information may come from a scheduled cell. The scheduled cell refers to a cell scheduled by the MC-DCI.

In one embodiment, the indication information may come from a reference cell in the scheduled cell. The reference cell includes at least one of the following:
a cell configured to calculate a size of the MC-DCI;
a cell configured to calculate a blind detection resource (e.g., BD or CCE, where the BD represents the blind detection and the CCE represents a control channel element) of the MC-DCI; or
a cell configured with a search space corresponding to the MC-DCI.

In one embodiment, the indication information may be carried in at least one of the following:
radio resource control (RRC) signalling, physical layer signalling, or media access control (MAC) layer signalling. The physical layer signalling includes, but is not limited to, the DCI, and the MAC layer signalling includes, but is not limited to, the medium access control control element (MAC CE).

In one embodiment, a plurality of relationships may exist between the first size and the second size. The network device processes the MC-DCI differently for each type of relationship. Finally, it can be ensured that the size of the MC-DCI is equal to the second size. Corresponding to the processing process of the network device for the MC-DCI, the blind detection process of the terminal for the MC-DCI will also be different. As a result, the terminal may perform the blind detection on the received MC-DCI according to the relationship between the first size and the second size, where the size of the MC-DCI for the blind detection is equal to the second size.

According to the embodiments of the present disclosure, the terminal may perform the blind detection on the received MC-DCI according to the relationship between the first size and the second size, and the size of the MC-DCI for the blind detection is equal to the second size. In this way, the size of the MC-DCI used by the terminal for the blind detection can be ensured to be the same as the second size indicated by the network device via the indication information. Additionally, the terminal and the network device can achieve a consistent understanding regarding the size of the corresponding MC-DCI, and it facilitates the improvement of the blind detection efficiency and scheduling performance of the MC-DCI.

In one embodiment, upon detecting the MC-DCI via the blind detection, the terminal may parse the MC-DCI to determine information indicated in the information field in the MC-DCI for the cell scheduled by the MC-DCI.

In one embodiment, the relationship between the first size and the second size includes at least one of the following:
the first size is less than the second size;
the first size is greater than the second size; or
the first size is equal to the second size.

In one embodiment, the network device may not process the MC-DCI in a case where the first size is equal to the second size. Correspondingly, the terminal may determine that the MC-DCI has not been processed, eliminating the need to deduce the process of the network device processing the MC-DCI, and directly performing the blind detection on the MC-DCI according to the second size.

The network device needs to process the MC-DCI accordingly to ensure that the size of the processed MC-DCI is the second size, in a case where the first size is different from the second size. Correspondingly, the terminal needs to deduce the process of the network device processing the MC-DCI to determine how the network device processes the MC-DCI, and then perform the blind detection on the MC-DCI processed by the network device according to the second size.

The following illustrates cases where the first size is different from the second size via several embodiments.

FIG. 2 is a schematic flowchart of a blind detection method for downlink control information according to another embodiment of the present disclosure. The blind detection method for the downlink control information may be performed by the terminal. As shown in FIG. 2, performing the blind detection on the received downlink control information according to the relationship between the first size and the second size includes the following steps S201 and S202.

In step S201, it is determined that a bit in the received downlink control information is zero-padded, in a case where the first size is less than the second size.

In step S202, the blind detection is performed on the zero-padded downlink control information.

It is to be noted that the embodiment shown in FIG. 2 may be implemented independently or in combination with at least one other embodiment in the present disclosure. The specific choices can be made as needed and are not limited to the present disclosure.

In one embodiment, the network device may perform zero padding on a bit in the MC-DCI, in a case where the first size is less than the second size. Correspondingly, the terminal may determine that the MC-DCI is zero-padded.

In one embodiment, the terminal may determine that the zero padding is performed after the bits corresponding to all information fields of the MC-DCI. In one embodiment, the terminal may determine that the zero padding is performed before the bits corresponding to all information fields of the MC-DCI. In one embodiment, the terminal may determine that each of the plurality of information fields included in the MC-DCI is zero-padded individually. For example, for one information field, it may be determined that the zero padding is performed after a bit corresponding to the one information field, or it may be determined that the zero padding is performed before the bit corresponding to the one information field.

In one embodiment, the terminal may perform the blind detection on the zero-padded MC-DCI after determining that a bit in the MC-DCI is zero-padded. After the bit in the MC-DCI is zero-padded, the size of the MC-DCI increases, for example, from the first size to the second size.

In one embodiment, a number of zero-padded bits is equal to a first difference between the second size and the first size. Accordingly, it can be ensured that the size of the MC-DCI is equal to the second size after the bit in the MC-DCI of the first size is zero-padded, enabling the terminal to perform the blind detection on the MC-DCI according to the second size.

In one embodiment, in a case where each of the plurality of information fields included in the MC-DCI is zero-padded individually, the number of zeros padded for each information field may be determined according to the number of the plurality of information fields and the first difference.

In one embodiment, the plurality of zero-padded information fields belongs to the same type, for example, type 2.

In one embodiment, the plurality of zero-padded information fields includes a plurality of types of information fields, for example, at least two of the following types: type 1-A, type 1-B, type 1-C, or type 2.

One information field of type 1-A is configured to indicate information of all scheduled cells, and the information indicated for each scheduled cell is the same. One information field of type 1-B is configured to indicate the information of all scheduled cells, and the information indicated for each scheduled cell may be different. One information field of type 1-C indicates the information of one scheduled cell. Different information fields in a plurality of information fields of type 2 indicate information of different scheduled cells, respectively.

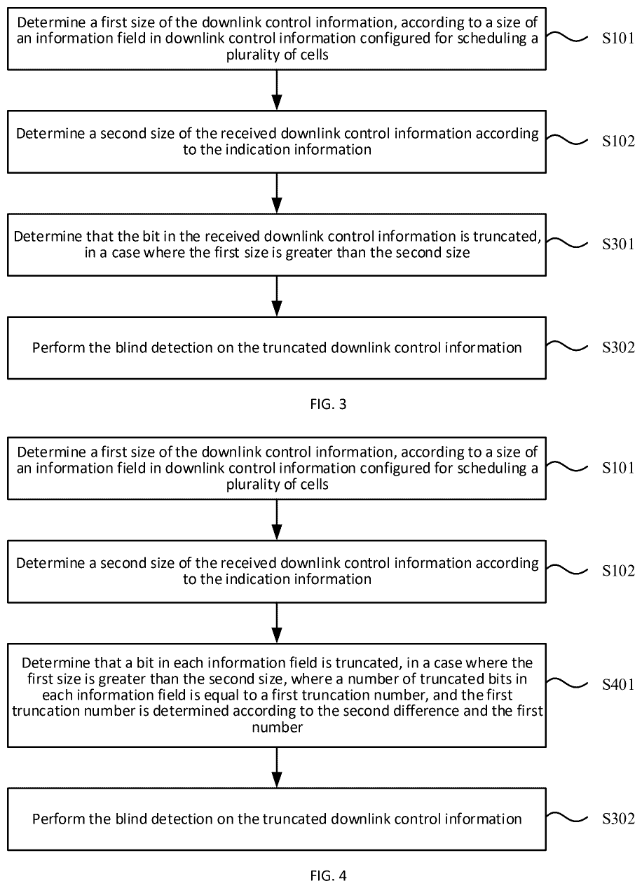

FIG. 3 is a schematic flowchart of a blind detection method for downlink control information according to another embodiment of the present disclosure. The blind detection method for the downlink control information may be performed by the terminal. As shown in FIG. 3, performing the blind detection on the received downlink control information, according to the relationship between the first size and the second size, includes the following steps S301 and S302.

In step S301, it is determined that the bit in the received downlink control information is truncated, in a case where the first size is greater than the second size.

In step S302, the blind detection is performed on the truncated downlink control information.

It is to be noted that the embodiment shown in FIG. 3 may be implemented independently or in combination with at least one other embodiment in the present disclosure. The specific choices can be made as needed and are not limited to those in the present disclosure.

In one embodiment, the network device may truncate the bit in the MC-DCI in a case where the first size is greater than the second size. Correspondingly, the terminal may determine that the MC-DCI is truncated.

The specific cases of MC-DCI truncation will be described in subsequent embodiments and will not be repeated here.

In one embodiment, the terminal may perform the blind detection on the truncated MC-DCI after determining that the bit in the MC-DCI is truncated. After the bit in the MC-DCI is truncated, the size of the MC-DCI becomes smaller, for example, from the first size to the second size.

In one embodiment, a number of truncated bits is equal to a second difference between the first size and the second size. Accordingly, it can be ensured that the size of the MC-DCI is equal to the second size after the bit in the MC-DCI of the first size is truncated, enabling the terminal to perform the blind detection on the MC-DCI according to the second size.

In one embodiment, the MC-DCI includes at least one information field.

In one embodiment, the type of the information field includes at least one of the following:
a first type, where the downlink control information includes at least one first type of information field, and an individual first type of information field in the at least one first type of information field indicates first information of an individual scheduled cell, respectively;
a second type, where the downlink control information includes one second type of information field which is configured to indicate second information of all scheduled cells scheduled by the downlink control information;
a third type, where the downlink control information includes one third type of information field which is configured to indicate an index of a third information combination of at least one scheduled cell; or
a fourth type, where the downlink control information includes one third type of information field configured to indicate fourth information of one scheduled cell.

In one embodiment, the information fields in the MC-DCI may be divided into several types based on the method for indicating information of the scheduled cell. The types of information fields include, but are not limited to, the above four types.

The first type may also be referred to as Type 2, the second type may also be referred to as Type 1-A, the third type may also be referred to as Type 1-B, and the fourth type may also be referred to as Type 1-C.

In one embodiment, the MC-DCI includes at least one information field. The bit in the MC-DCI is truncated, which may be that a bit in the at least one information field in the MC-DCI is truncated.

In one embodiment, the truncated bit includes at least one of the following:
at least one most significant bit (MSB) in the at least one information field;
at least one least significant bit (LSB) in the at least one information field; or
a bit other than a bit configured to indicate a type of information field in the at least one information field.

In one embodiment, in a case where the network device performs truncation on the bit in the MC-DCI, the network device truncates, among the bits corresponding to all information fields of the MC-DCI, a number of bits corresponding to the second difference starting from either the first bit or the last bit. Correspondingly, the terminal may determine the truncated number of bits corresponding to the second difference starting from either the first bit or the last bit in the MC-DCI.

In one embodiment, in a case where the network device performs truncation on the bit in the MC-DCI, the network device may truncate a bit in the at least one information field included in the MC-DCI. Correspondingly, the terminal may determine that the bit in the at least one information field included in the MC-DCI is truncated.

In one embodiment, the network device may determine at least one most significant bit in the at least one information field, and then truncate the determined at least one most significant bit.

For example, one information field may be determined from the at least one information field, and then the at least one most significant bit in the information field may be truncated. For example, one antenna ports information field may be determined from 4 antenna ports information fields, such as a fourth antenna ports information field, in a case where the above 4 antenna ports information fields occupy 24 bits and 4 bits need to be truncated. In this case, the 4 most significant bits in the fourth antenna ports information field may be truncated. Correspondingly, the terminal may determine that the 4 most significant bits in the fourth antenna ports information field are truncated. As a result, the blind detection may be performed on the MC-DCI according to a second number, where the second number is obtained by reducing the first number by 4 bits.

For example, at least one most significant bit in each of the at least one information field may be truncated. For example, 1 most significant bit in each antenna ports information field may be truncated, in a case where the above 4 antenna ports information fields occupy 24 bits and 4 bits need to be truncated. In this case, the size of the MC-DCI is reduced by 4 bits. Correspondingly, the terminal may determine that the 1 most significant bit in each antenna ports information field is truncated. As a result, the blind detection may be performed on the MC-DCI according to the second number, where the second number is obtained by reducing the first number by 4 bits.

In one embodiment, the network device may determine at least one least significant bit in at least one information field, and then truncate the determined at least one least significant bit.

For example, one information field may be determined from the at least one information field, and then at least one least significant bit in the information field may be truncated. For example, one antenna ports information field may be determined from 4 antenna ports information fields, such as a fourth antenna ports information field, in a case where the above 4 antenna ports information fields occupy 24 bits and 4 bits need to be truncated. In this case, the 4 least significant bits in the fourth antenna ports information field may be truncated. Correspondingly, the terminal may determine that the 4 least significant bits in the fourth antenna ports information field are truncated. As a result, the blind detection may be performed on the MC-DCI according to the second number, where the second number is obtained by reducing the first number by 4 bits.

For example, at least one least significant bit in each of the at least one information field may be truncated. For example, 1 least significant bit in each antenna ports information field may be truncated, in a case where the above 4 antenna ports information fields occupy 24 bits and 4 bits need to be truncated. In this case, the size of the MC-DCI is reduced by 4 bits. Correspondingly, the terminal may determine that the 1 least significant bit in each antenna ports information field is truncated. As a result, the blind detection may be performed on the MC-DCI according to the second number, where the second number is obtained by reducing the first number by 4 bits.

In one embodiment, the at least one information field belongs to the same type, and different information fields in the at least one information field indicate information of different scheduled cells, respectively.

In one embodiment, the at least one information field belonging to the same type includes at least one of the following: a modulation and coding scheme (MCS) information field, a hybrid automatic repeat request (HARQ) process number information field, a frequency domain resource allocation (FDRA) information field, an antenna ports information field, a precoding information and number of layers information field, a transmit power control (TPC) command for scheduled PUSCH information field, a phase-tracking reference signal-demodulation reference signal (PTRS-DMRS) association information field, or a sounding reference signal (SRS) resource indicator information field.

For example, a plurality of antenna ports information fields may belong to the same type. For example, a plurality of FDRA information fields may belong to the same type.

Taking the at least one information field belonging to the same type as an example, an individual information field may indicate information of an individual cell. MC-DCI may include at least one information field in a case where at least one cell is scheduled via the MC-DCI, where the individual information field indicates information of an individual scheduled cell.

The MC-DCI may indicate information of a plurality of scheduled cells via a plurality of information fields, in a case where the plurality of cells is scheduled by the MC-DCI. As a result, a correspondence between the bit occupied by the at least one information field and an identifier of at least one scheduled cell needs to be determined.

For example, the correspondence between the bit occupied by the at least one information field and the identifier of the at least one scheduled cell (the cell currently scheduled by the MC DCI) may be obtained by: mapping the at least one scheduled cell to the bit occupied by the at least one information field in an ascending order of cell identifiers, or mapping the at least one scheduled cell to the bit occupied the by at least one information field.

For example, the correspondence between the bit occupied by the at least one information field and the identifier of the at least one scheduled cell (the cell currently scheduled by the MC DCI) may be obtained by: mapping the at least one scheduled cell to the bit occupied by the at least one information field in a descending order of the cell identifiers, or mapping the at least one scheduled cell to the bit occupied by the at least one information field.

It is to be noted that the number of bits occupied by each information field of at least one information field may be the same or different.

The antenna ports information field is taken as an example of the information field. For example, the MC-DCI contains 4 antenna ports information fields. The first antenna ports information field is configured to indicate information related to an antenna port of Cell #1, the second antenna ports information field is configured to indicate information related to an antenna port of Cell #2, the third antenna ports information field is configured to indicate information related to an antenna port of Cell #3, and the fourth antenna ports information field is configured to indicate information related to an antenna port of Cell #4, in a case where 4 cells Cell #1, Cell #2, Cell #3, and Cell #4 are scheduled via the MC-DCI.

In a case where the number of bits occupied by each antenna ports information field is different, for example, the size of the first antenna ports information field is 4 bits, the size of the second antenna ports information field is 6 bits, the size of the third antenna ports information field is 4 bits, and the size of the fourth antenna ports information field is 5 bits, therefore, the 4 antenna ports information fields occupy 19 bits.

In a case where the number of bits occupied by each antenna ports information field is the same, for example, the size of the first antenna ports information field is 6 bits, the size of the second antenna ports information field is 6 bits, the size of the third antenna ports information field is 6 bits, and the size of the fourth antenna ports information field is 6 bits, therefore, then the 4 antenna ports information fields occupy 24 bits.

The embodiments of the present disclosure may be applicable to the case where the number of bits occupied by each information field is the same, or may be applicable to the case where the number of bits occupied by each information field is different. The present disclosure is illustratively described below mainly based on the case where the number of bits occupied by each antenna ports information field is the same.

In one embodiment, the network device may determine the bit other than the bit configured to indicate the type of the information field from the at least one information field. The bit other than the bit configured to indicate the type of the information field is referred to as other bit. Therefore, the other bit may be truncated.

For example, one information field may be determined from the at least one information field, and the other bit in the information field may be determined. The bit corresponding to the number of second difference may be truncated from the other bit.

For example, the other bit may be determined from each information field, and then, a first truncation number may be determined according to the second difference and the number of information fields, and a bit may be truncated from the other bit in each information field according to the first truncation number.

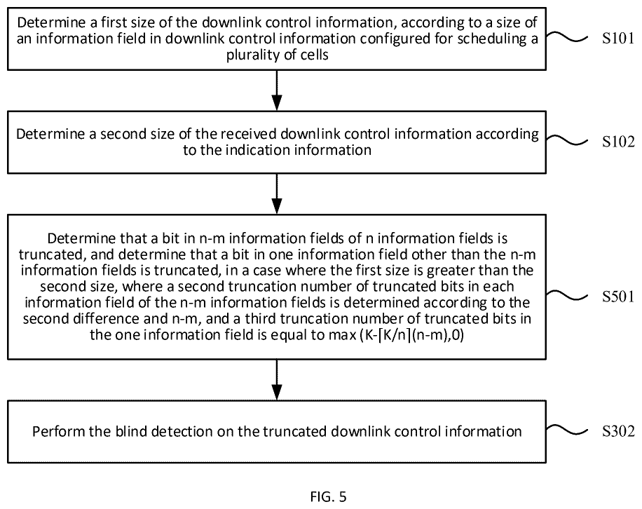

FIG. 4 is a schematic flowchart of a blind detection method for downlink control information according to another embodiment of the present disclosure. The blind detection method for the downlink control information may be performed by the terminal. As shown in FIG. 4, determining that the bit in the received downlink control information is truncated includes the following step S401.

In step S401, it is determined that a bit in each information field is truncated, where a number of truncated bits in each information field is equal to the first truncation number, and the first truncation number is determined according to the second difference and the first number. For example, the first truncation number is equal to the quotient of the number of at least one information field and the second difference.

It is to be noted that the embodiment shown in FIG. 4 can be implemented independently or in combination with at least one other embodiment in the present disclosure. The specific choices can be made as needed and are not limited to the present disclosure.

In one embodiment, the network device may determine the first truncation number according to the number of at least one information field included in the MC-DCI and the second difference, in a case where the second difference is an integer multiple of the first number of at least one information field. Then the bit in each information field is truncated, where the number of truncated bits in each information field is equal to the first truncation number. Correspondingly, the terminal may determine that the bit in each information field is truncated, and the number of truncated bits in each information field is equal to the first truncation number.

Taking the above 4 antenna ports information fields as an example, the number of at least one information field is 4. The first truncation number is 1, in a case where the second difference is 4. In this case, the network device may truncate 1 bit in each antenna ports information field. Correspondingly, the terminal may determine that 1 bit in each antenna ports information field is truncated. As a result, the blind detection may be performed on the MC-DCI according to a second number, where the second number is obtained by reducing the first number by 4 bits.

FIG. 5 is a schematic flowchart of a blind detection method for downlink control information according to another embodiment of the present disclosure. The blind detection method for the downlink control information may be performed by the terminal. As shown in FIG. 5, determining that the bit in the received downlink control information is truncated includes the following step S501.

In step S501, it is determined that a bit in n−m information fields of n information fields is truncated, and it is determined that a bit in one information field other than the n−m information fields is truncated, where the number of at least one information field is n, m is an integer, and 0≤m<n, a second truncation number of truncated bits in each information field of the n−m information fields is determined according to the second difference and n−m, and a third truncation number of truncated bits in the one information field is equal to max (K−┌K/n┐(n−m),0), where K is the second difference.

It is to be noted that the embodiment shown in FIG. 5 may be implemented independently or in combination with at least one other embodiment in the present disclosure. The specific choices can be made as needed and are not limited to those in the present disclosure.

In one embodiment, taking at least one information field as an example of n information fields, the terminal may determine that a bit in n−m+1 information fields of the n information fields is truncated, in a case where the second difference is not an integer multiple of the first number of at least one information field.

In the n−m+1 information fields, a second truncation number of truncated bits in each information field of the n−m information fields may be determined according to the second difference K and n−m. For example, the second truncation number is equal to └K/(n−m)┘, where └K/(n−m)┘ represents the floor of K/(n−m). In the n−m+1 information fields, a third truncation number of truncated bits in the one information field other than the n−m information fields may be equal to max (K−┌K/n┐(n−m),0), where ┌K/n┐ represents a ceiling of K/n.

In one embodiment, m may be indicated by a network device or determined based on a protocol agreement. For example, the protocol agreement specifies that m is the maximum value of all i, where all i meet K−┌K/n┐(n−i)<┌K/n┐, and i is an integer.

For example, in a case where n=4 and the second difference K=4, m is configured by the network device as 0; therefore, there is no need to calculate max (K−┌K/n┐(n−m), 0). The second truncation number is equal to └K/(n−m)┘=└4/(4−0)┘=1, and then, 1 bit is truncated from each information field of the 4 information fields.

For example, in a case where n=4 and the second difference K=3, m is configured by the network device as 1; therefore, the third truncation number max (K−┌K/n┐(n−m), 0) may be calculated as 0. The second truncation number is equal to └K/(n−m)┘=└3/(4−1)┘=1, and n−m+1=4. As a result, in the 4 information fields, 1 bit is truncated from each information field of 3 information fields, and 0 bit is truncated from the remaining 1 information field, meaning that no bit is truncated.

For example, in a case where n=4 and the second difference K=5, m is configured by the network device as 2; therefore, the third truncation number max (K−┌K/n┐(n−m), 0) may be calculated as 1. The second truncation number is equal to └K/(n−m)┘=└5/(4−2)┘=2, and n−m+1=3. As a result, in 3 information fields of the 4 information fields, 2 bits are truncated from each information field of 2 information fields, and 1 bit is truncated from the remaining 1 information field.

It is to be noted that methods for determining the number of truncated bits in each information field are not limited to the above several embodiments, and the specific methods may be indicated by the network device or determined based on the protocol agreement.

For example, the number of at least one information field is n.

The number of truncated bits in each information field is equal, which is equal to K/n, in a case where the second difference K is an integer multiple of n.

The number of truncated bits in each information field may be unequal, in a case where the second difference K is greater than n and is not an integer multiple of n. For example, the number of truncated bits in n−1 information fields is equal to └K/n┘, and the number of truncated bits in the remaining 1 information field is equal to └K/n┘+K mod n, where mod represents a modulo operation.

The number of truncated bits in each information field may be unequal, in a case where the second difference K is less than n. For example, K information fields may be determined from n information fields, and the number of truncated bits in each information field of the K information fields is equal to 1. For example, the K information fields may be the first K information fields of the n information fields.

For example, it may be determined that the number of truncated bits in 3 of the 4 information fields is equal to 1, and the number of truncated bits in the remaining 1 information field is equal to 2, in a case where n=4, K=5, K is greater than n and K is not an integer multiple of n.

In one embodiment, the at least one information field includes a plurality of types of information fields.

In one embodiment, the plurality of types includes at least two of the following types: type 1-A, type 1-B, type 1-C, or type 2.

It is to be noted that different types of information fields may indicate the same information or may indicate a plurality of types of information.

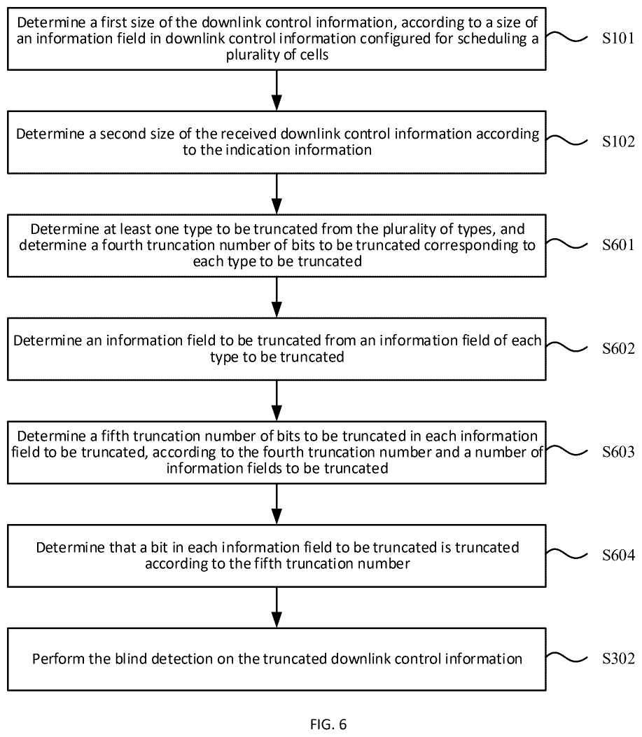

FIG. 6 is a schematic flowchart of a blind detection method for downlink control information according to another embodiment of the present disclosure. The blind detection method for the downlink control information may be performed by the terminal. As shown in FIG. 6, determining that the bit in the received downlink control information is truncated includes the following steps S601-S604

In step S601, at least one type to be truncated is determined from the plurality of types, and a fourth truncation number of bits to be truncated corresponding to each type to be truncated is determined.

In step S602, an information field to be truncated is determined from an information field of each type to be truncated.

In step S603, a fifth truncation number of bits to be truncated in each information field to be truncated is determined according to the fourth truncation number and a number of information fields to be truncated.

In step S604, it is determined that a bit in each information field to be truncated is truncated according to the fifth truncation number.

It is to be noted that the embodiment shown in FIG. 6 may be implemented independently or in combination with at least one other embodiment in the present disclosure. The specific choices can be made as needed and are not limited to the present disclosure.

In one embodiment, in a case where the network device truncates the bit in the information field included in the MC-DCI, the network device may truncate bits for different types of information fields.

In one embodiment, the network device may determine at least one type to be truncated from the plurality of types, and determine the fourth truncation number of bits to be truncated corresponding to each type to be truncated. Then, an information field to be truncated is determined from the information field of each type to be truncated. Furthermore, the fifth truncation number of bits to be truncated in each information field to be truncated is determined according to the fourth truncation number and the number of information fields to be truncated. Finally, the bit in each information field to be truncated is truncated according to the fifth truncation number.

Correspondingly, the terminal may determine the at least one type to be truncated from the plurality of types, and determine the fourth truncation number of bits to be truncated corresponding to each type to be truncated. Then, the information field to be truncated is determined from the information field of each type to be truncated. Furthermore, the fifth truncation number of bits to be truncated in each information field to be truncated is determined according to the fourth truncation number and the number of information fields to be truncated. Finally, it is determined that the bit in each information field to be truncated is truncated according to the fifth truncation number.

The fourth truncation number of bits to be truncated corresponding to each type to be truncated is equal, which is equal to K/p, in a case where the second difference K is an integer multiple of the number p of types in the at least one type to be truncated. The fourth truncation number of bits to be truncated corresponding to each type to be truncated may be unequal, in a case where the second difference K is not an integer multiple of p. For example, the fourth truncation number of bits to be truncated corresponding to p−1 types to be truncated is equal to └K/p┘, and the fourth truncation number of bits to be truncated corresponding to the remaining 1 type to be truncated is equal to └K/p┘+K mod p.

For example, it may be determined that in 4 types to be truncated, the fourth number of bits to be truncated corresponding to 3 types to be truncated is 2, and the fourth number of bits to be truncated corresponding to the remaining 1 type to be truncated is equal to 3, in a case where p=4 and K=9.

Further, the fifth truncation number of bits to be truncated in each information field to be truncated may be determined according to the fourth truncation number and the number of information fields to be truncated, after the fourth number of bits to be truncated corresponding to each type to be truncated is determined.

The method for determining the fifth truncation number is similar to the methods for determining the first truncation number, the second truncation number, the third truncation number, etc., in the above embodiments.

For example, 3 information fields to be truncated may be determined from antenna port information fields, in a case where the remaining 1 type to be truncated is an antenna port, and the fourth number of bits to be truncated corresponding to the remaining 1 type to be truncated is equal to 3. Then, the fifth number of truncated bits in each information field to be truncated is equal to the fourth number/3=1, and the terminal may determine that 1 bit is truncated from each information field to be truncated.

In one embodiment, the at least one information field includes an information field configured to indicate a plurality of types of information.

In one embodiment, the plurality of types of information includes at least two of the following information: MCS information, HARQ process number, FDRA information, antenna ports information, Precoding information and number of layers information, SRS resource indicator, TPC command for scheduled PUSCH, PTRS-DMRS association information, or SRS resource indicator.

It is to be noted that the information field indicating the same information may belong to the same type or different types.

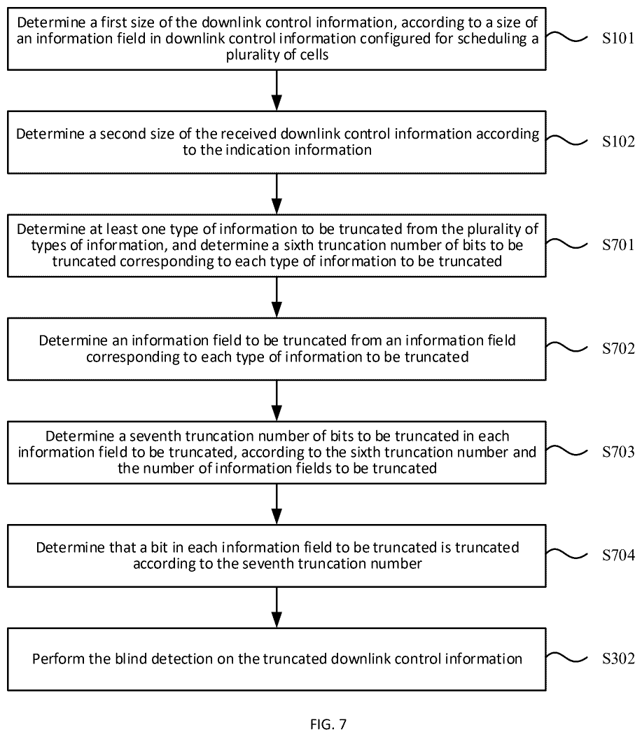

FIG. 7 is a schematic flowchart of a blind detection method for downlink control information according to another embodiment of the present disclosure. The blind detection method for the downlink control information may be performed by the terminal. As shown in FIG. 7, determining that the bit in the received downlink control information is truncated includes the following steps S701-S704.

In step S701, at least one type of information to be truncated is determined from the plurality of types of information, and a sixth truncation number of bits to be truncated corresponding to each type of information to be truncated is determined.

In step S702, an information field to be truncated is determined from an information field corresponding to each type of information to be truncated.

In step S703, a seventh truncation number of bits to be truncated in each information field to be truncated is determined according to the sixth truncation number and the number of information fields to be truncated.

In step S704, it is determined that a bit in each information field to be truncated is truncated according to the seventh truncation number.

It is to be noted that the embodiment shown in FIG. 7 may be implemented independently or in combination with at least one other embodiment in the present disclosure. The specific choices can be made as needed and are not limited to the present disclosure.

In one embodiment, in a case where the network device truncates the bit in the information field included in the MC-DCI, the network device may truncate bits in information fields indicating different information.

In one embodiment, the network device may determine at least one type of information to be truncated from the plurality of types of information, and determine the sixth truncation number of bits to be truncated corresponding to each type of information to be truncated. Then, the information field to be truncated is determined from the information field corresponding to each type of information to be truncated. Furthermore, the seventh truncation number of bits to be truncated in each information field to be truncated is determined according to the sixth truncation number and the number of information fields to be truncated. Finally, the bit in each information field to be truncated is truncated according to the seventh truncation number.

Correspondingly, the terminal may determine the at least one type of information to be truncated from the plurality of types of information, and determine the sixth truncation number of bits to be truncated corresponding to each type of information to be truncated. Then, the information field to be truncated is determined from the information field corresponding to each type of information to be truncated. Furthermore, the seventh truncation number of bits to be truncated in each information field to be truncated is determined according to the sixth truncation number and the number of information fields to be truncated. Finally, it is determined that the bit in each information field to be truncated is truncated according to the seventh truncation number.

The sixth truncation number of bits to be truncated corresponding to each type of information to be truncated is equal, which is equal to K/q, in a case where the second difference K is an integer multiple of the number of information types q in the at least one type of information to be truncated. The sixth truncation number of bits to be truncated corresponding to each type of information to be truncated may be unequal, in a case where the second difference K is not an integer multiple of q. For example, the sixth truncation number of bits to be truncated corresponding to q−1 types of information to be truncated is equal to └K/q┘, and the sixth truncation number of bits to be truncated corresponding to the remaining 1 type of information to be truncated is equal to └K/q┘+K mod q.

For example, it can be determined that in 3 types of information to be truncated, the sixth number of bits to be truncated corresponding to 2 types of information to be truncated is 3, and the sixth number of bits to be truncated corresponding to the remaining 1 type of information to be truncated is equal to 4, in a case where q=3 and K=10.

Further, the seventh truncation number of bits to be truncated in each information field to be truncated may be determined according to the sixth truncation number and the number of information fields to be truncated, after the six number of bits to be truncated corresponding to each type of information to be truncated is determined.

The method for determining the seventh truncation number is similar to the methods for determining the first truncation number, the second truncation number, the third truncation number, etc., in the above embodiments.

For example, 4 information fields to be truncated may be determined from the FDRA information field, in a case where the remaining 1 type to be truncated is the FDRA information, and the sixth number of bits to be truncated corresponding to the remaining 1 type of information to be truncated is equal to 4. Therefore, the seventh number of truncated bits in each information field to be truncated is equal to the sixth number/4=1, and the terminal may determine that 1 bit is truncated from each information field to be truncated.

It is to be noted that the method by which the terminal determines that the bit in the received downlink control information is zero-padded is similar to the method by which the terminal determines that the bit in the received downlink control information is truncated.

In one embodiment, determining that the bit in the received downlink control information is zero-padded includes: determining that each information field is zero-padded, where the number of zero-padded bits in each information field is equal to a first zero padding number, and the first zero padding number is determined according to the second difference and the first number. For example, the first zero padding number is equal to the quotient of the number of at least one information field and the second difference.

In one embodiment, determining that the bit in the received downlink control information is zero-padded includes: determining that n−m information fields of n information fields are zero-padded, and determining that one information field other than the n−m information fields is zero-padded, where the number of at least one information field is n, m is an integer, and 0≤m<n;

A second zero padding number of zero-padded bits in each information field of the n−m information fields is determined according to the second difference and n−m, and a third zero padding number of zero-padded bits in the one information field is equal to max (K−┌K/n┐(n−m),0), where K is the second difference.

In one embodiment, at least one information field belongs to the same type, and different information fields in the at least one information field indicate information of different scheduled cells, respectively.

In this case, determining that the bit in the received downlink control information is zero-padded includes: determining that the bit in each information field is zero-padded, where the number of zero-padded bits in each information field is equal to the first zero padding number, and the first zero padding number is determined according to the second difference and the first number.

Alternatively, determining that the bit in the received downlink control information is zero-padded includes: determining that the bit in n−m information fields of n information fields is zero-padded, and determining that the bit in the one information field other than the n−m information fields is zero-padded, where the number of at least one information field is n. A second zero padding number of zero-padded bits in each information field of the n−m information fields is determined according to the second difference and n−m, and a third zero padding number of zero-padded bits in the one information field is equal to max (K−┌K/n┘(n−m),0), where K is the second difference.

In one embodiment, the at least one information field includes the plurality of types of information fields.

In this case, determining that the bit in the received downlink control information is zero-padded includes:
determining at least one type to be zero-padded from the plurality of types, and determining a fourth zero padding number of bits to be zero-padded corresponding to each type to be zero-padded;
determining an information field to be zero-padded from an information field of each type to be zero-padded;
determining a fifth zero padding number of bits to be zero-padded from each information field to be zero-padded, according to the fourth zero padding number and the number of information fields to be zero-padded; and
determining that the bit in each information field to be zero-padded is zero-padded according to the fifth zero padding number.

In one embodiment, the at least one information field includes information fields configured to indicate the plurality of types of information.

In this case, determining that the bit in the received downlink control information is zero-padded includes:
determining at least one type of information to be zero-padded from the plurality of types of information, and determining a sixth zero padding number of bits to be zero-padded corresponding to each type of information to be zero-padded;
determining an information field to be zero-padded from the information field corresponding to each type of information to be zero-padded;
determining a seventh zero padding number of bits to be zero-padded from each information field to be zero-padded, according to the sixth zero padding number and the number of information fields to be zero-padded; and
determining that the bit in each information field to be zero-padded is zero-padded according to the seventh zero padding number.

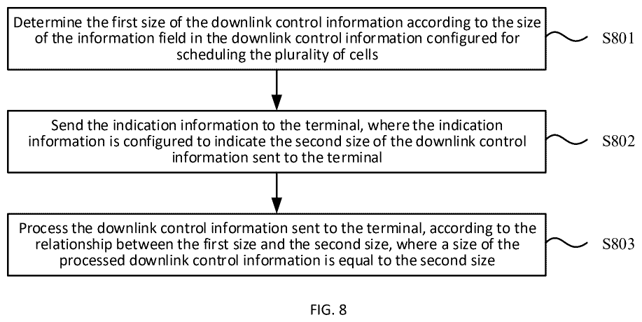

FIG. 8 is a schematic flowchart of a method for processing downlink control information according to an embodiment of the present disclosure. The method for processing the downlink control information shown in this embodiment may be performed by the network device, which may communicate with the terminal. The network device includes, but is not limited to, a base station in a communication system such as a 4G base station, a 5G base station, and a 6G base station. The terminal includes, but is not limited to, a mobile phone, a tablet computer, a wearable device, a sensor, an Internet of Things device, and other communication devices.

As shown in FIG. 8, the method for processing the downlink control information may include the following steps S801-S803.

In step S801, the first size of the downlink control information is determined according to the size of the information field in the downlink control information configured for scheduling the plurality of cells.

In step S802, the indication information is sent to the terminal, where the indication information is configured to indicate the second size of the downlink control information sent to the terminal.

In step S803, the downlink control information sent to the terminal is processed according to the relationship between the first size and the second size, where a size of the processed downlink control information is equal to the second size.

In one embodiment, the network device may determine the first size of the MC-DCI according to the size of the information field in the MC-DCI, such as determining that the first size is equal to the sum of sizes of all information fields in the MC-DCI. The network device may also send the indication information to the terminal, where the indication information is configured to indicate the second size of the downlink control information sent to the terminal.

In one embodiment, the indication information may be sent to the terminal via the scheduling cell. The scheduling cell refers to the cell where the terminal is camped on when receiving the MC-DCI.

In one embodiment, the indication information may be sent to the terminal via the scheduled cell. The scheduled cell refers to the cell scheduled by the MC-DCI.

In one embodiment, the indication information may be sent to the terminal via the reference cell in the scheduled cell. The reference cell includes at least one of the following:
the cell configured to calculate the size of the MC-DCI;
the cell configured to calculate the blind detection resource (e.g., the BD or the CCE) of the MC-DCI; or
the cell configured with the search space corresponding to the MC-DCI.

In one embodiment, the indication information may be carried in at least one of the following:
the RRC signalling, the physical layer signalling, or the MAC layer signalling. The physical layer signalling includes, but is not limited to, the DCI, and the MAC layer signalling includes, but is not limited to, the MAC CE.

In one embodiment, since the plurality of relationships may exist between the first size and the second size. The network device processes the MC-DCI differently for each type of relationship. Finally, it can be ensured that the size of the MC-DCI is equal to the second size. Corresponding to the processing process of the network device for the MC-DCI, the blind detection process of the terminal for the MC-DCI will also be different. As a result, the terminal may perform the blind detection on the received MC-DCI according to the relationship between the first size and the second size, where the size of the MC-DCI for the blind detection is equal to the second size.

According to the embodiments of the present disclosure, the network device may process the MC-DCI sent to the terminal according to the relationship between the first size and the second size, so that the size of the processed MC-DCI is equal to the second size. Then, the network device sends the processed MC-DCI to the terminal. Accordingly, it can be ensured that the size of the MC-DCI sent to the terminal is the same as the second size indicated by the network device via indication information. Additionally, the terminal and the network device can achieve a consistent understanding regarding the size of the corresponding MC-DCI, and it facilitates the improvement of the blind detection efficiency and scheduling performance of the MC-DCI.

In one embodiment, upon detecting the MC-DCI via the blind detection, the terminal may parse the MC-DCI to determine the information indicated in the information field in the MC-DCI for the cell scheduled by the MC-DCI.

In one embodiment, the relationship between the first size and the second size includes at least one of the following:
the first size is less than the second size;
the first size is greater than the second size; or
the first size is equal to the second size.

In one embodiment, the network device may not process the MC-DCI in a case where the first size is equal to the second size. Correspondingly, the terminal may determine that the MC-DCI has not been processed, eliminating the need to deduce the process of the network device processing the MC-DCI, and directly performing the blind detection on the MC-DCI according to the second size.

The network device needs to process the MC-DCI accordingly to ensure that the size of the processed MC-DCI is the second size, in a case where the first size is different from the second size. Correspondingly, the terminal needs to deduce the process of the network device processing the MC-DCI to determine how the network device processes the MC-DCI, and then perform the blind detection on the MC-DCI processed by the network device according to the second size.

The following illustrates cases where the first size is different from the second size via several embodiments.

In one embodiment, processing the downlink control information sent to the terminal, according to the relationship between the first size and the second size includes: performing zero padding on a bit in the downlink control information sent to the terminal, in a case where the first size is less than the second size.

In one embodiment, the network device may perform zero padding on the bit in the MC-DCI, in a case where the first size is less than the second size. Correspondingly, the terminal may determine that the MC-DCI is zero-padded.

In one embodiment, the network device may perform the zero padding after the bits corresponding to all information fields of the MC-DCI. In one embodiment, the network device may perform the zero padding before the bits corresponding to all information fields of the MC-DCI. In one embodiment, the network device may determine that each of the plurality of information fields included in the MC-DCI is zero-padded. For example, for one information field, the zero padding is performed after the bit corresponding to the one information field, or the zero padding is performed before the bit corresponding to the one information field.

In one embodiment, in a case where the network device performs the zero padding on the MC-DCI, the network device may send the zero-padded MC-DCI to the terminal. After the bit in the MC-DCI is zero-padded, the size of the MC-DCI will increase, for example, from the first size to the second size.

In one embodiment, the number of zero-padded bits is equal to the first difference between the second size and the first size. Accordingly, it can be ensured that the size of the MC-DCI is equal to the second size, after the bit in the MC-DCI of the first size is zero-padded, enabling the terminal to perform the blind detection on the MC-DCI according to the second size.

In one embodiment, in a case where each of the plurality of information fields included in the MC-DCI is zero-padded individually, the number of zeros padded for each information field may be determined according to the number of the plurality of information fields and the first difference.

In one embodiment, the plurality of zero-padded information fields belongs to the same type, for example, type 2.

In one embodiment, the plurality of zero-padded information fields includes a plurality of types of information fields, for example, at least two of the following types: type 1-A, type 1-B, type 1-C, or type 2.

One information field of type 1-A is configured to indicate information of all scheduled cells, and the information indicated for each scheduling cell is the same. One information field of type 1-B is configured to indicate the information of all scheduled cells, and the information indicated for each scheduling cell may be different. One information field of type 1-C indicates the information of one scheduled cell. Different information fields in a plurality of information fields of type 2 indicate information of different scheduled cells, respectively.

In one embodiment, processing the downlink control information sent to the terminal, according to the relationship between the first size and the second size includes: truncating a bit in the downlink control information sent to the terminal, in a case where the first size is greater than the second size.

In one embodiment, the network device may truncate the bit in the MC-DCI in a case where the first size is greater than the second size. Correspondingly, the terminal may determine that the MC-DCI is truncated.

In one embodiment, the network device may send the truncated MC-DCI to the terminal after determining that the bit in the MC-DCI is truncated. The size of the MC-DCI becomes smaller, for example, from the first size to the second size, after the bit in the MC-DCI is truncated.

In one embodiment, the number of truncated bits is equal to the second difference between the first size and the second size. Accordingly, it can be ensured that the size of the MC-DCI is equal to the second size after the bit in the MC-DCI of the first size is truncated, enabling the size of the MC-DCI sent by the network device to the terminal to be the second size, and further enabling the terminal to perform the blind detection on the MC-DCI according to the second size.

In one embodiment, the MC-DCI includes at least one information field.

In one embodiment, the type of the information field includes at least one of the following:
the first type, where the downlink control information includes at least one first type of information field, and the individual first type of information field in the at least one first type of information field indicates first information of an individual scheduled cell, respectively;
the second type, where the downlink control information includes one second type of information field, which is configured to indicate second information of all scheduled cells scheduled by the downlink control information;
the third type, where the downlink control information includes one third type of information field, which is configured to indicate the index of the third information combination of at least one scheduled cell; or
the fourth type, where the downlink control information includes one third type of information field, which is configured to indicate the fourth information of one scheduled cell.

In one embodiment, the information fields in the MC-DCI may be divided into several types based on the method for indicating the information of scheduled cells. The types of information fields include, but are not limited to, the above four types.

The first type may also be referred to as Type 2, the second type may also be referred to as Type 1-A, the third type may also be referred to as Type 1-B, and the fourth type may also be referred to as Type 1-C.

In one embodiment, the MC-DCI includes at least one information field. The bit in the MC-DCI is truncated, which may be that the bit in the at least one information field in the MC-DCI is truncated.

In one embodiment, the truncated bit includes at least one of the following:
at least one MSB in the at least one information field;
at least one LSB in the at least one information field; or
the bit other than the bit configured to indicate the type of the information field in the at least one information field.

In one embodiment, in a case where the network device performs truncation on the bit in the MC-DCI, the network device truncates a bit corresponding to the number of second difference among the bits corresponding to all information fields of the MC-DCI, starting from either the first bit or the last bit. Correspondingly, the terminal may determine the truncated bit in the MC-DCI corresponding to the number of second difference, where the truncated bit is truncated starting from the first bit or the last bit.

In one embodiment, in a case where the network device performs truncation on the bit in the MC-DCI, the network device may truncate the bit in the at least one information field included in the MC-DCI. Correspondingly, the terminal may determine that the bit in at least one information field included in the MC-DCI is truncated.

In one embodiment, the network device may determine at least one most significant bit in the at least one information field, and then truncate the determined at least one most significant bit.

For example, one information field may be determined from at least one information field, and then, the at least one most significant bit in the information field may be truncated. For example, one antenna ports information field may be determined from 4 antenna ports information fields, such as a fourth antenna ports information field, in a case where the above 4 antenna ports information fields occupy 24 bits and 4 bits need to be truncated. In this case, the 4 most significant bits in the fourth antenna ports information field may be truncated. Correspondingly, the terminal may determine that the 4 most significant bits in the fourth antenna ports information field are truncated. As a result, the blind detection may be performed on the MC-DCI according to the second number, where the second number is obtained by reducing the first number by 4 bits.

For example, at least one most significant bit in each of the at least one information field may be truncated. For example, 1 most significant bit in each antenna ports information field may be truncated, in a case where the above 4 antenna ports information fields occupy 24 bits and 4 bits need to be truncated. In this case, the size of the MC-DCI is reduced by 4 bits. Correspondingly, the terminal may determine that the 1 most significant bit in each antenna ports information field is truncated. As a result, the blind detection may be performed on the MC-DCI according to the second number, where the second number is obtained by reducing the first number by 4 bits.

In one embodiment, the network device may determine at least one least significant bit in at least one information field, then truncate the determined at least one least significant bit.

For example, one information field may be determined from the at least one information field, and then, at least one least significant bit in the information field may be truncated. For example, one antenna ports information field may be determined from 4 antenna ports information fields, such as a fourth antenna ports information field, in a case where the above 4 antenna ports information fields occupy 24 bits and 4 bits need to be truncated. In this case, the 4 least significant bits in the fourth antenna ports information field may be truncated. Correspondingly, the terminal may determine that the 4 least significant bits in the fourth antenna ports information field are truncated. As a result, the blind detection may be performed on the MC-DCI according to the second number, where the second number is obtained by reducing the first number by 4 bits.

For example, at least one least significant bit in each of the at least one information field may be truncated. For example, 1 least significant bit in each antenna ports information field may be truncated, in a case where the above 4 antenna ports information fields occupy 24 bits and 4 bits need to be truncated. In this case, the size of the MC-DCI is reduced by 4 bits. Correspondingly, the terminal may determine that the 1 least significant bit in each antenna ports information field is truncated. As a result, the blind detection may be performed on the MC-DCI according to the second number, where the second number is obtained by reducing the first number by 4 bits.

In one embodiment, the at least one information field belongs to the same type, and different information fields in the at least one information field indicate information of different scheduled cells, respectively.

In one embodiment, the at least one information field belonging to the same type includes at least one of the following: the MCS information field, the HARQ process number information field, the FDRA information field, the antenna ports information field, the Precoding information and number of layers information field, the TPC command for scheduled PUSCH information field, the PTRS-DMRS association information field, or the SRS resource indicator information field.

For example, the plurality of antenna ports information fields may belong to the same type. For example, the plurality of FDRA information fields may belong to the same type.

Taking the at least one information field belonging to the same type as an example, an individual information field may indicate information of an individual cell. MC-DCI may include at least one information field, in a case where at least one cell is scheduled via the MC-DCI, where the individual information field indicates information of an individual scheduled cell.

The MC-DCI may indicate information of the plurality of scheduled cells via the plurality of information fields, in a case where the plurality of cells is scheduled by the MC-DCI. As a result, the correspondence between the bit occupied by the at least one information field and an identifier of at least one scheduled cell needs to be determined.

For example, the correspondence between the bit occupied by the at least one information field and the identifier of the at least one scheduled cell (the cell currently scheduled by the MC DCI) may be obtained by: mapping the at least one scheduled cell to the bit occupied by the at least one information field in the ascending order of cell identifiers, or mapping the at least one scheduled cell to the bit occupied by the at least one information field.

For example, the correspondence between the bit occupied by the at least one information field and the identifier of the at least one scheduled cell (the cell currently scheduled by the MC DCI) may be obtained by: mapping the at least one scheduled cell to correspond to the bit occupied by the at least one information field in the descending order of the cell identifiers, or mapping the at least one scheduled cell to the bit occupied by the at least one information field.

It is to be noted that the number of bits occupied by each information field of the at least one information field may be the same or different.

The antenna ports information field is taken as an example of the information field. For example, the MC-DCI contains 4 antenna ports information fields. The first antenna ports information field is configured to indicate the information related to the antenna port of Cell #1, the second antenna ports information field is configured to indicate the information related to the antenna port of Cell #2, the third antenna ports information field is configured to indicate the information related to the antenna port of Cell #3, and the fourth antenna ports information field is configured to indicate the information related to the antenna port of Cell #4, in a case where 4 cells Cell #1, Cell #2, Cell #3, and Cell #4 are scheduled via the MC-DCI.

In a case where the number of bits occupied by each antenna ports information field is different, for example, the size of the first antenna ports information field is 4 bits, the size of the second antenna ports information field is 6 bits, the size of the third antenna ports information field is 4 bits, and the size of the fourth antenna ports information field is 5 bits, therefore, the 4 antenna ports information fields occupy 19 bits.

In a case where the number of bits occupied by each antenna ports information field is the same, for example, the size of the first antenna ports information field is 6 bits, the size of the second antenna ports information field is 6 bits, the size of the third antenna ports information field is 6 bits, and the size of the fourth antenna ports information field is 6 bits, therefore, the 4 antenna ports information fields occupy 24 bits.

The embodiments of the present disclosure may be applicable to the case where the number of bits occupied by each information field is the same, or may be applicable to the case where the number of bits occupied by each information field is different. The present disclosure is illustratively described below mainly based on the case where the number of bits occupied by each antenna ports information field is the same.

In one embodiment, the network device may determine the bit other than the bits configured to indicate the type of the information field from the at least one information field. The bit other than the bit configured to indicate the type of the information field is referred to as other bit, for example. Therefore, the other bit may be truncated.

For example, one information field may be determined from the at least one information field, and the other bit in the information field may be determined. Then, the bit corresponding to the number of second difference may be truncated from the other bit.

For example, the other bit may be determined from each information field. Then, a first truncation number may be determined according to the second difference and the number of information fields, and the bit may be truncated from the other bit in each information field according to the first truncation number.

In one embodiment, truncating the bit in the downlink control information sent to the terminal includes: truncating the bit in each information field, where the number of truncated bits in each information field is equal to the first truncation number, and the first truncation number is determined according to the second difference and the first number.

In one embodiment, the network device may determine the first truncation number according to the number of at least one information field included in the MC-DCI and the second difference, in a case where the second difference is the integer multiple of the first number of at least one information field. Then the bit in each information field is truncated, where the number of truncated bits in each information field is equal to the first truncation number. Correspondingly, the terminal may determine that the bit in each information field is truncated, and the number of truncated bits in each information field is equal to the first truncation number.

Taking the above 4 antenna ports information fields as an example, the number of at least one information field is 4. The first truncation number is 1, in a case where the second difference is 4. Then, the network device may truncate 1 bit in each antenna ports information field. Correspondingly, the terminal may determine that 1 bit in each antenna ports information field is truncated. As a result, the blind detection may be performed on the MC-DCI according to the second number, where the second number is obtained by reducing the first number by 4 bits.

In one embodiment, truncating the bit in the downlink control information sent to the terminal includes: truncating the bit in n−m information fields of n information fields, and truncating the bit in one information field other than the n−m information fields, where the number of at least one information field is n.

A second truncation number of truncated bits in each information field of the n−m information fields is determined according to the second difference and n−m, and a third truncation number of truncated bits in the one information field is equal to max (K−┌K/n┐(n−m),0), where K is the second difference.

In one embodiment, taking at least one information field as an example of n information fields, the network device may truncate the bit in n−m+1 information fields of the n information fields, in a case where the second difference is not the integer multiple of the first number of at least one information field.

In the n−m+1 information fields, the second truncation number of truncated bits in each information field of the n−m information fields may be determined according to the second difference K and n−m. For example, the second truncation number is equal to └K/(n−m)┘, where └K/(n−m)┘ represents the floor of K/(n−m). In the n−m+1 information fields, the third truncation number of truncated bits in the one information field other than the n−m information fields may be equal to max (K−┌K/n┐(n−m),0), where ┌K/n┐ represents the ceiling of K/n.

In one embodiment, m may be indicated by a network device or determined based on a protocol agreement. For example, the protocol agreement specifies that m is the maximum value of all i, where all i meet K−┌K/n┐(n−i)<┌K/n┐, and i is an integer.

For example, in a case where n=4 and the second difference K=4, m is configured by the network device as 0; therefore, there is no need to calculate max (K−┌K/n┐(n−m), 0). The second truncation number is equal to └K/(n−m)┘=└4/(4−0)┘=1, and then, 1 bit is truncated from each information field of the 4 information fields.

For example, in a case where n=4 and the second difference K=3, m is configured by the network device as 1; therefore, the third truncation number max (K−┌K/n┐(n−m), 0) may be calculated as 0. The second truncation number is equal to └K/(n−m)┘=└3/(4−1)┘=1, and n−m+1=4. As a result, in the 4 information fields, 1 bit is truncated from each information field of 3 information fields, and 0 bit is truncated from the remaining 1 information field, meaning that no bit is truncated.

For example, in a case where n=4 and the second difference K=5, m is configured by the network device as 2; therefore, the third truncation number max (K−┌K/n┐(n−m), 0) may be calculated as 1. The second truncation number is equal to └K/(n−m)┘=└5/(4−2)┘=2, and n−m+1=3. As a result, in 3 information fields of the 4 information fields, 2 bits are truncated from each information field of 2 information fields, and 1 bit is truncated from the remaining 1 information field.

It is to be noted that methods for determining the number of truncated bits in each information field are not limited to the above several embodiments, and the specific methods may be indicated by the network device or determined based on the protocol agreement.

For example, the number of at least one information field is n.

The number of truncated bits in each information field is equal, which is equal to K/n, in a case where the second difference K is an integer multiple of n.

The number of truncated bits in each information field may be unequal, in a case where the second difference K is greater than n and is not an integer multiple of n. For example, the number of truncated bits in n−1 information fields is equal to └K/n┘, and the number of truncated bits in the remaining 1 information field is equal to └K/n┘+K mod n, where mod represents a modulo operation.

The number of truncated bits in each information field may be unequal, in a case where the second difference K is less than n. For example, K information fields may be determined from n information fields, and the number of truncated bits in each information field of the K information fields is equal to 1.

For example, in a case where n=4, K=5, K is greater than n and K is not an integer multiple of n, it may be determined that the number of truncated bits in 3 of the 4 information fields is equal to 1, and the number of truncated bits in the remaining 1 information field is equal to 2.

In one embodiment, the at least one information field includes the plurality of types of information fields.

In one embodiment, the plurality of types includes at least two of the following types: type 1-A, type 1-B, type 1-C, or type 2.

It is to be noted that different types of information fields may indicate the same information or may indicate the plurality of types of information.

In one embodiment, truncating the bit in the downlink control information sent to the terminal includes:
determining at least one type to be truncated from the plurality of types, and determining the fourth truncation number of bits to be truncated corresponding to each type to be truncated;
determining the information field to be truncated from the information field of each type to be truncated;
determining the fifth truncation number of bits to be truncated in each information field to be truncated according to the fourth truncation number and the number of information fields to be truncated; and
truncating the bit in each information field to be truncated is truncated according to the fifth truncation number.

In one embodiment, when truncating the bit in the information field included in the MC-DCI, the network device may truncate the bit in different types of information fields.

In one embodiment, the network device may determine at least one type to be truncated from the plurality of types, and determine the fourth truncation number of bits to be truncated corresponding to each type to be truncated. Then, the information field to be truncated is determined from the information field of each type to be truncated. Furthermore, the fifth truncation number of bits to be truncated in each information field to be truncated is determined according to the fourth truncation number and the number of information fields to be truncated. Finally, the bit in each information field to be truncated is truncated according to the fifth truncation number.

Correspondingly, the terminal may determine the at least one type to be truncated from the plurality of types, and determine the fourth truncation number of bits to be truncated corresponding to each type to be truncated. Then, the information field to be truncated is determined from the information field of each type to be truncated. Furthermore, the fifth truncation number of bits to be truncated in each information field to be truncated is determined according to the fourth truncation number and the number of information fields to be truncated. Finally, it is determined that the bit in each information field to be truncated is truncated according to the fifth truncation number.

The fourth truncation number of bits to be truncated corresponding to each type to be truncated is equal, which is equal to K/p, in a case where the second difference K is an integer multiple of the number p of types in the at least one type to be truncated. The fourth truncation number of bits to be truncated corresponding to each type to be truncated may be unequal, in a case where the second difference K is not an integer multiple of p. For example, the fourth truncation number of bits to be truncated corresponding to p−1 types to be truncated is equal to └K/p┘, and the fourth truncation number of bits to be truncated corresponding to the remaining 1 type to be truncated is equal to └K/p┘+K mod p.

For example, it may be determined that in 4 types to be truncated, the fourth number of bits to be truncated corresponding to 3 types to be truncated is 2, and the fourth number of bits to be truncated corresponding to the remaining 1 type to be truncated is equal to 3, in a case where p=4 and K=9.

Further, the fifth truncation number of bits to be truncated in each information field to be truncated may be determined according to the fourth truncation number and the number of information fields to be truncated, after the fourth number of bits to be truncated corresponding to each type to be truncated is determined.

The method for determining the fifth truncation number is similar to the methods for determining the first truncation number, the second truncation number, the third truncation number, etc., in the above embodiments.

For example, 3 information fields to be truncated may be determined from the antenna port information fields, in a case where the remaining 1 type to be truncated is the antenna port, and the fourth number of bits to be truncated corresponding to the remaining 1 type to be truncated is equal to 3. Then, the fifth number of truncated bits in each information field to be truncated is equal to the fourth number/3=1, and the network device determines that 1 bit is truncated from each information field to be truncated.

In one embodiment, the at least one information field includes the information field configured to indicate the plurality of types of information.

In one embodiment, the plurality of types of information includes at least two of the following information: the MCS information, the HARQ process number, the FDRA information, the antenna ports information, the precoding information and number of layers information, the SRS resource indicator, the TPC command for scheduled PUSCH, the PTRS-DMRS association information, or the SRS resource indicator.

It is to be noted that the information fields indicating the same information may belong to the same type or different types.

In one embodiment, truncating the bit in the downlink control information sent to the terminal includes:
determining at least one type of information to be truncated from the plurality of types of information, and determining the sixth truncation number of bits to be truncated corresponding to each type of information to be truncated;
determining the information field to be truncated from the information field corresponding to each type of information to be truncated;
determining the seventh truncation number of bits to be truncated in each information field to be truncated, according to the sixth truncation number and the number of information fields to be truncated; and
truncating the bit in each information field to be truncated according to the seventh truncation number.

In one embodiment, in a case where the network device truncates the bit in the information field included in the MC-DCI, the network device may truncate bits in information fields indicating different information.

In one embodiment, the network device may determine at least one type of information to be truncated from the plurality of types of information, and determine the sixth truncation number of bits to be truncated corresponding to each type of information to be truncated. Then, the information field to be truncated is determined from the information fields corresponding to each type of information to be truncated. Furthermore, the seventh truncation number of bits to be truncated in each information field to be truncated is determined according to the sixth truncation number and the number of information fields to be truncated. Finally, the bit in each information field to be truncated is truncated according to the seventh truncation number.

Correspondingly, the terminal may determine the at least one type of information to be truncated from the plurality of types of information, and determine the sixth truncation number of bits to be truncated corresponding to each type of information to be truncated. Then, the information field to be truncated is determined from the information field corresponding to each type of information to be truncated. Furthermore, the seventh truncation number of bits to be truncated in each information field to be truncated is determined according to the sixth truncation number and the number of information fields to be truncated. Finally, it is determined that the bit in each information field to be truncated is truncated according to the seventh truncation number.

The sixth truncation number of bits to be truncated corresponding to each type of information to be truncated is equal, which is equal to K/q, in a case where the second difference K is an integer multiple of the number of information types q in the at least one type of information to be truncated. The sixth truncation number of bits to be truncated corresponding to each type of information to be truncated may be unequal, in a case where the second difference K is not an integer multiple of q. For example, the sixth truncation number of bits to be truncated corresponding to q−1 types of information to be truncated is equal to └K/q┘, and the sixth truncation number of bits to be truncated corresponding to the remaining 1 type of information to be truncated is equal to └K/q┘+K mod q.

For example, it can be determined that in 3 types of information to be truncated, the sixth number of bits to be truncated corresponding to 2 types of information to be truncated is 3, and the sixth number of bits to be truncated corresponding to the remaining 1 type of information to be truncated is equal to 4, in a case where q=3 and K=10.

Further, the seventh truncation number of bits to be truncated in each of the information fields to be truncated may be determined according to the sixth truncation number and the number of information fields to be truncated, after the sixth number of bits to be truncated corresponding to each type of information to be truncated is determined.

The method for determining the seventh truncation number is similar to the methods for determining the first truncation number, the second truncation number, the third truncation number, etc., in the above embodiments.

For example, 4 information fields to be truncated may be determined from the FDRA information field, in a case where the remaining 1 information to be truncated is the FDRA information, and the sixth number of bits to be truncated corresponding to the remaining 1 type of information to be truncated is equal to 4. Therefore, the seventh number of truncated bits in each information field to be truncated is equal to the sixth number/4=1, and the network device may truncate 1 bit from each information field to be truncated.

It is to be noted that the method by which the network device performs the zero padding on the downlink control information sent to the terminal is similar to the method by which the network device truncates the bit in the downlink control information sent to the terminal.

In one embodiment, performing the zero padding on the downlink control information sent to the terminal includes: performing the zero padding on each information field, where the number of zero-padded bits in each information field is equal to the first zero padding number, and the first zero padding number is determined according to the second difference and the first number. For example, the first zero padding number is equal to the quotient of the number of at least one information field and the second difference.

In one embodiment, performing the zero padding on the downlink control information sent to the terminal includes: performing the zero padding on n−m information fields of n information fields, and performing the zero padding on one information field other than the n−m information fields, where the number of at least one information field is n, m is an integer, and 0≤m<n;

The second zero padding number of zero-padded bits in each information field of the n−m information fields is determined according to the second difference and n−m, and the third zero padding number of zero-padded bits in the one information field is equal to max (K−┌K/n┐(n−m),0), where K is the second difference.

In one embodiment, at least one information field belongs to the same type, and different information fields in the at least one information field indicate information of different scheduled cells, respectively.

In this case, performing the zero padding on the downlink control information sent to the terminal includes: performing the zero padding on the bit in each information field, where the number of zero-padded bits in each information field is equal to the first zero padding number, and the first zero padding number is determined according to the second difference and the first number.

Alternatively, performing the zero padding on the downlink control information sent to the terminal includes: performing the zero padding on the bit in n−m information fields of n information fields, and performing the zero padding on the bit in the one information field other than the n−m information fields, where the number of at least one information field is n. The second zero padding number of zero-padded bits in each information field of the n−m information fields is determined according to the second difference and n−m, and the third zero padding number of zero-padded bits in the one information field is equal to max (K−┌K/n┐(n−m),0), where K is the second difference.

In one embodiment, the at least one information field includes the plurality of types of information fields.

In this case, performing the zero padding on the downlink control information sent to the terminal includes:
determining at least one type to be zero-padded from the plurality of types, and determining the fourth zero padding number of bits to be zero-padded corresponding to each type to be zero-padded;
determining the information field to be zero-padded from the information field of each type to be zero-padded;
determining the fifth zero padding number of bits to be zero-padded from each information field to be zero-padded, according to the fourth zero padding number and the number of information fields to be zero-padded; and
performing the zero padding on the bit in each information field to be zero-padded according to the fifth number.

In one embodiment, the at least one information field includes information fields configured to indicate the plurality of types of information.

In this case, performing the zero padding on the downlink control information sent to the terminal includes:
determining at least one type of information to be zero-padded from the plurality of types of information, and determining the sixth zero padding number of bits to be zero-padded corresponding to each type of information to be zero-padded;
determining the information field to be zero-padded from the information field corresponding to each type of information to be zero-padded;
determining the seventh zero padding number of bits to be zero-padded from each information field to be zero-padded, according to the sixth zero padding number and the number of information fields to be zero-padded; and
performing the zero padding on the bit in each information field to be zero-padded according to the seventh number.

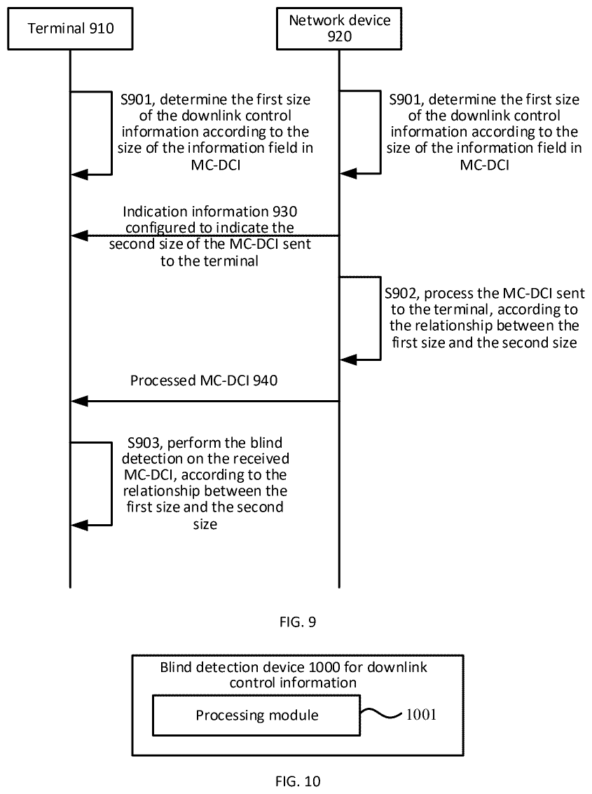

FIG. 9 is a schematic diagram showing interaction between the terminal 910 and the network device 920 according to an embodiment of the present disclosure.

As shown in FIG. 9, the network device 920 may perform steps S901 and S902. The terminal 910 may perform steps S901 and S903.

In step S901, determine the first size of the downlink control information according to the size of the information field in MC-DCI.

In step S902, process the MC-DCI sent to the terminal, according to the relationship between the first size and the second size.

In step S903, perform the blind detection on the received MC-DCI, according to the relationship between the first size and the second size.

As shown in FIG. 9, the terminal 910 may also receive indication information 930 and processed MC-DCI 940, where the indication information 930 is configured to indicate the second size of the MC-DCI sent to the terminal.

As shown in FIG. 9, the network device may determine the first size of downlink control information according to the size of the information field in the MC-DCI; send the indication information to the terminal, where the indication information is configured to indicate the second size of the MC-DCI sent to the terminal; and process the MC-DCI sent to the terminal, according to the relationship between the first size and the second size, where the size of the processed MC-DCI is equal to the second size. The network device may further send the processed MC-DCI to the terminal.

Correspondingly, the terminal may determine the first size of the downlink control information according to the size of the information field in the MC-DCI; determine the second size of the received MC-DCI according to the indication information; and perform the blind detection on the received MC-DCI according to the relationship between the first size and the second size, where the size of the MC-DCI for the blind detection is equal to the second size.

Accordingly, it can be ensured that the size of the MC-DCI used by the terminal for the blind detection is the same as the second size indicated by the network device via the indication information. Additionally, the terminal and the network device can achieve a consistent understanding regarding the size of the corresponding MC-DCI, and it facilitates the improvement of blind detection efficiency and scheduling performance of the MC-DCI.

In one embodiment, the network device may not process the MC-DCI in a case where the first size is equal to the second size. Correspondingly, the terminal may determine that the MC-DCI has not been processed, eliminating the need to deduce the process of the network device processing the MC-DCI, and directly performing the blind detection on the MC-DCI according to the second size.

In one embodiment, the network device may perform the zero padding on the MC-DCI sent to the terminal, and send the zero-padded MC-DCI to the terminal, in a case where the first size is less than the second size. Correspondingly, the terminal may determine that the received MC-DCI is zero-padded and then perform the blind detection on the zero-padded MC-DCI.

In one embodiment, the network device may truncate the bit in the MC-DCI sent to the terminal, and send the bit-truncated MC-DCI to the terminal, in a case where the first size is greater than the second size. The terminal may determine that the bit in the received MC-DCI is truncated, then perform the blind detection on the truncated downlink control information.

It is to be noted that for other contents involved in this embodiment, reference is made to the description of the relevant contents in the previous embodiments, which will not be repeated here.

Corresponding to the aforementioned embodiments of the blind detection method for the downlink control information and the method for processing the downlink control information, the present disclosure also provides embodiments of a blind detection device for downlink control information and a device for processing downlink control information.

FIG. 10 is a schematic block diagram of the blind detection device for the downlink control information according to an embodiment of the present disclosure. As shown in FIG. 10, the blind detection device 1000 for the downlink control information includes:
a processing module 1001 configured to determine the first size of the downlink control information, according to the size of the information field in downlink control information configured for scheduling the plurality of cells; determine the second size of the received downlink control information according to the indication information; and perform the blind detection on the received downlink control information according to the relationship between the first size and the second size, where the size of the downlink control information for the blind detection is equal to the second size.

In one embodiment, the relationship between the first size and the second size includes at least one of the following:
the first size is less than the second size;
the first size is greater than the second size; or
the first size is equal to the second size.

In one embodiment, the processing module 1001 is configured to determine that the bit in the received downlink control information is zero-padded, in a case where the first size is less than the second size, and perform the blind detection on the zero-padded downlink control information.

In one embodiment, the number of zero-padded bits is equal to the first difference between the second size and the first size.

In one embodiment, the processing module 1001 is configured to determine that the bit in the received downlink control information is truncated, in a case where the first size is greater than the second size, and perform the blind detection on the truncated downlink control information.

In one embodiment, the number of truncated bits is equal to the second difference between the first size and the second size.

In one embodiment, the downlink control information includes at least one information field.

In one embodiment, the truncated bit includes at least one of the following:
at least one most significant bit in the at least one information field;
at least one least significant bit in the at least one information field; or
the bit other than the bit configured to indicate the type of the information field in the at least one information field.

In one embodiment, the at least one information field belongs to the same type, and different information fields in the at least one information field indicate information of different scheduled cells, respectively.

In one embodiment, the processing module 1001 is configured to determine that the bit in each information field is truncated, where the number of truncated bits in each information field is equal to the first truncation number, and the first truncation number is determined according to the second difference and the first number.

In one embodiment, the processing module 1001 is configured to determine that bit in the n−m information fields of the n information fields is truncated, and determine that the bit in one information field other than the n−m information fields is truncated, where the number of at least one information field is n. The second truncation number of truncated bits in each information field of the n−m information fields is determined according to the second difference and n−m, and the third truncation number of truncated bits in the one information field is equal to max (K−⇄K/n┐(n−m),0), where K is the second difference.

In one embodiment, the at least one information field includes the plurality of types of information fields.

In one embodiment, the processing module 1001 is configured to determine at least one type to be truncated from the plurality of types, and determine the fourth truncation number of bits to be truncated corresponding to each type to be truncated; determine the information field to be truncated from the information fields of each type to be truncated; determine the fifth truncation number of bits to be truncated in each information fields to be truncated, according to the fourth truncation number and the number of information fields to be truncated; and determine that the bit in each information field to be truncated is truncated according to the fifth truncation number.

In one embodiment, the at least one information field includes the information field configured to indicate the plurality of types of information.

In one embodiment, the processing module 1001 is configured to determine at least one type of information to be truncated from the plurality of types of information, and determine the sixth truncation number of bits to be truncated corresponding to each type of information to be truncated; determine the information field to be truncated from the information field corresponding to each type of information to be truncated; determine the seventh truncation number of bits to be truncated in each information field to be truncated, according to the sixth truncation number and the number of information fields to be truncated; and determine that the bit in each information field to be truncated is truncated according to the seventh truncation number.

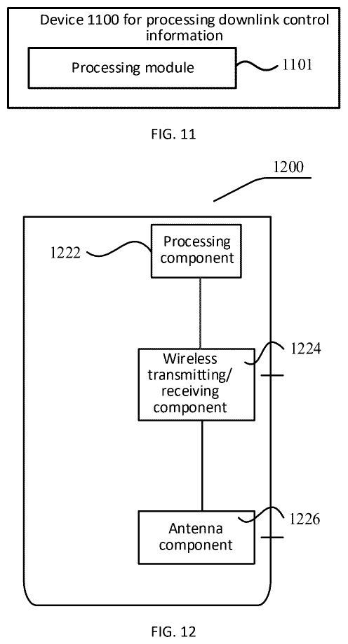

FIG. 11 is a schematic block diagram of the device for processing downlink control information according to an embodiment of the present disclosure. As shown in FIG. 11, the device 1100 for processing the downlink control information includes:
a processing module 1101, configured to determine the first size of the downlink control information according to the size of the information field in the downlink control information configured for scheduling the plurality of cells; send the indication information to the terminal, where the indication information is configured to indicate the second size of the downlink control information sent to the terminal; and process the downlink control information sent to the terminal, according to the relationship between the first size and the second size, where the size of the processed downlink control information is equal to the second size.

In one embodiment, the relationship between the first size and the second size includes at least one of the following:
the first size is less than the second size;
the first size is greater than the second size; or
the first size is equal to the second size.

In one embodiment, the processing module 1101 is configured to perform the zero padding on the bit in the downlink control information sent to the terminal, in a case where the first size is less than the second size.

In one embodiment, the number of zero-padded bits is equal to the first difference between the second size and the first size.

In one embodiment, the processing module 1101 is configured to truncate the bit in the downlink control information sent to the terminal, in a case where the first size is greater than the second size.

In one embodiment, the number of truncated bits is equal to the second difference between the first size and the second size.

In one embodiment, the downlink control information includes at least one information field.

In one embodiment, the truncated bit includes at least one of the following:
at least one most significant bit in the at least one information field;
at least one least significant bit in the at least one information field; or
the bit other than the bit configured to indicate the type of the information field in the at least one information field.

In one embodiment, the at least one information field belongs to the same type, and different information fields in the at least one information field indicate information of different scheduled cells, respectively.

In one embodiment, the processing module 1101 is configured to truncate the bit in each information field, where the number of truncated bits in each information field is equal to the first truncation number, and the first truncation number is determined according to the second difference and the first number.

In one embodiment, the processing module 1101 is configured to truncate the bit in the n−m information fields of the n information fields, and truncate the bit in one information field other than the n−m information fields, where the number of at least one information field is n. The second truncation number of truncated bits in each information field of the n−m information fields is determined according to the second difference and n−m, and the third truncation number of truncated bits in the one information field is equal to max (K−┌K/n┐(n−m),0), where K is the second difference.

In one embodiment, the at least one information field includes the plurality of types of information fields.

In one embodiment, the processing module 1101 is configured to determine at least one type to be truncated from the plurality of types, and determine the fourth truncation number of bits to be truncated corresponding to each type to be truncated; determine the information field to be truncated from the information field of each type to be truncated; determine the fifth truncation number of bits to be truncated in each information field to be truncated, according to the fourth truncation number and the number of information fields to be truncated; and truncate the bit in each information field to be truncated according to the fifth truncation number.

In one embodiment, the at least one information field includes the information field configured to indicate the plurality of types of information.

In one embodiment, the processing module 1101 is configured to determine at least one type of information to be truncated from the plurality of types of information, and determine the sixth truncation number of bits to be truncated corresponding to each type of information to be truncated; determine the information field to be truncated from the information field corresponding to each type of information to be truncated; determine the seventh truncation number of bits to be truncated in each information field to be truncated, according to the sixth truncation number and the number of information fields to be truncated; and truncate the bit in each information field to be truncated according to the seventh truncation number.

Since device embodiments correspond to method embodiments, reference may be made to the relevant parts of the partial description of method embodiments. The device embodiments described above are merely illustrative, where modules described as separate components may or may not be physically separated, and components displayed as modules may or may not be physical modules, meaning that the components may be located at a one location or distributed over a plurality of network modules. Parts or all of the modules may be selected according to actual needs to achieve the purpose of the solution in this embodiment. One having ordinary skill in the art will be able to understand and implement the solution without any creative effort.

An embodiment of the present disclosure also provides a system for sending downlink control information, including the terminal and the network device, where the terminal is configured to perform the blind detection method for the downlink control information described in any of the above embodiments, and the network device is configured to implement the method for processing the downlink control information described in any of the above embodiments.

An embodiment of the present disclosure also provides a terminal, including: a processor; and a memory that stores a computer program, where the computer program, when executed by the processor, implements the blind detection method for the downlink control information described in any of the above embodiments.

An embodiment of the present disclosure also provides a network device, including: a processor; and a memory that stores a computer program, where the computer program, when executed by the processor, implements the method for processing downlink control information described in any of the above embodiments.

An embodiment of the present disclosure also provides a non-transitory computer-readable storage medium storing a computer program, where the computer program, when executed by a processor, implements the blind detection method for the downlink control information described in any of the above embodiments.

An embodiment of the present disclosure also provides a non-transitory computer-readable storage medium storing a computer program, where the computer program, when executed by a processor, implements the method for processing the downlink control information described in any of the above embodiments.

As shown in FIG. 12, FIG. 12 is a schematic block diagram of a device 1200 for processing the downlink control information according to an embodiment of the present disclosure. The device 1200 may be a base station. Referring to FIG. 12, the device 1200 includes a processing component 1222, a wireless transmitting/receiving component 1224, an antenna component 1226, and a signal processing portion dedicated to a wireless interface. The processing component 1222 may further include one or more processors. One of the processors in the processing component 1222 may be configured to implement the method for processing the downlink control information described in any of the above embodiments.

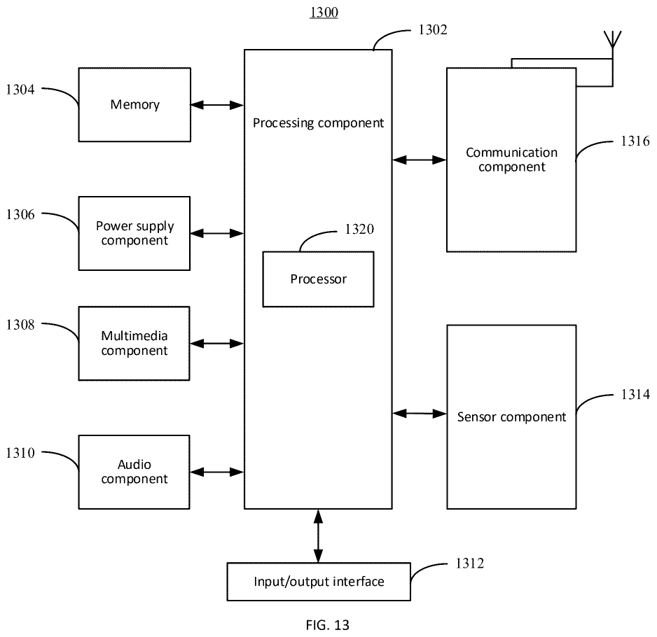

FIG. 13 is a schematic block diagram of a blind detection device 1300 for the downlink control information according to an embodiment of the present disclosure. For example, the device 1300 may be a terminal, such as a mobile phone, a computer, a digital broadcast terminal, a message transceiver device, a game console, a tablet device, a medical device, a fitness device, or a personal digital assistant.

Referring to FIG. 13, the device 1300 may include one or more of the following components: a processing component 1302, a memory 1304, a power supply component 1306, a multimedia component 1308, an audio component 1310, an input/output (I/O) interface 1312, a sensor component 1314, and a communication component 1316.

The processing component 1302 generally controls the overall operation of the device 1300, such as operations associated with display, telephone calls, data communications, camera operations, and recording operations. The processing component 1302 may include one or more processors 1320 to execute instructions to implement all or part of the steps of the blind detection method for downlink control information described in any of the above embodiments. In addition, the processing component 1302 may include one or more modules to facilitate interaction between the processing component 1302 and other components. For example, the processing component 1302 may include a multimedia module to facilitate interaction between the multimedia component 1308 and the processing component 1302.

As used herein, the term processor may refer to one processor that performs the defined functions or a plurality of processors that collectively perform defined functions, such that the execution of the individual defined functions may be divided amongst such processors.

The memory 1304 is configured to store various types of data to support operations in the device 1300. Examples of such data include instructions for any application or method operating on the device 1300, contact data, phonebook data, messages, pictures, videos, etc.

The power supply component 1306 supplies power to the various components of the device 1300. The power supply component 1306 may include a power supply management system, one or more power supplies, and other components associated with generating, managing, and distributing power for the device 1300.

The multimedia component 1308 includes a screen that provides an output interface between the device 1300 and a user. In some embodiments, the screen may include a liquid crystal display (LCD) and a touch panel (TP). In a case of including the touch panel, the screen may be implemented as a touch screen to receive an input signal from a user.

The audio component 1310 is configured to at least one of output or input an audio signal. For example, the audio component 1310 includes one microphone (MIC). The microphone is configured to receive an external audio signal in a case where the device 1300 is in an operational mode, such as a call mode, a recording mode, or a voice recognition mode. The received audio signal may be further stored in the memory 1304 or sent via the communication component 1316. In some embodiments, the audio component 1310 also includes one speaker configured to output the audio signal.

The I/O interface 1312 provides an interface between the processing component 1302 and a peripheral interface module. The above peripheral interface module may be a keyboard, click wheel, or button. These buttons may include, but are not limited to: a home button, a volume button, a power button, and a lock button.

The sensor component 1314 includes one or more sensors configured to provide status assessment of various aspects for the device 1300.

The communication component 1316 is configured to facilitate communication between the device 1300 and other devices in a wired or wireless manner. The device 1300 can access a wireless network based on a communication standard, such as Wi-Fi, 2G, 3G, 4G LTE, 5G NR, or a combination of them. In an example, the communication component 1316 receives a broadcast signal or broadcast-related information from an external broadcast management system via a broadcast channel. In an example, the communication component 1316 further includes a near field communication (NFC) module to facilitate short-range communications. For example, the NFC module may be implemented based on radio frequency identification (RFID) technology, infrared data association (IrDA) technology, ultra-wideband (UWB) technology, Bluetooth (BT) technology, and other technologies.

In an example, the device 1300 can be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, which is configured to implement the blind detection method for the downlink control information described in any of the above embodiments.

In an example, a non-transitory computer-readable storage medium including instructions is also provided, such as a memory 1304 including instructions. The above instructions can be executed by the processor 1320 of the device 1300 to implement the blind detection method for the downlink control information described in any of the above embodiments. For example, the non-transitory computer-readable storage medium may be a read-only memory (ROM), a random access memory (RAM), a compact disc read-only memory (CD-ROM), a magnetic tape, a floppy disk, an optical data storage device, etc.

Other implementations of the present disclosure will be readily conceivable to those skilled in the art from consideration of the specification and practice of the disclosure disclosed here. The present disclosure is intended to cover any modifications, uses, or adaptations of the present disclosure, which follow the general principles of the present disclosure and include common general knowledge or customary technical means in the technical field that are not disclosed in the present disclosure. The specification and embodiments are considered as examples merely, and the true scope and spirit of the present disclosure are defined by the following claims.

It is to be understood that the present disclosure is not limited to the precise structures described above and shown in the accompanying drawings, and various modifications and changes may be made without departing from the scope thereof. The scope of the present disclosure is limited by the appended claims merely.

1. A blind detection method for downlink control information, performed by a terminal, comprising:
determining a first size of the downlink control information, according to a size of an information field in downlink control information configured for scheduling a plurality of cells;
determining a second size of received downlink control information according to indication information; and
performing blind detection on the received downlink control information, according to a relationship between the first size and the second size, wherein a size of the downlink control information for the blind detection is equal to the second size.

2. The method according to claim 1, wherein the relationship between the first size and the second size comprises at least one of the following:
the first size is less than the second size;
the first size is greater than the second size; or
the first size is equal to the second size.

3. The method according to claim 2, wherein performing the blind detection on the received downlink control information, according to the relationship between the first size and the second size comprises:
determining that a bit in the received downlink control information is zero-padded, in a case where the first size is less than the second size; and
performing the blind detection on the zero-padded downlink control information; or
wherein performing the blind detection on the received downlink control information, according to the relationship between the first size and the second size comprises:
determining that a bit in the received downlink control information is truncated, in a case where the first size is greater than the second size; and
performing the blind detection on the truncated downlink control information.

4. The method according to claim 3, wherein a number of zero-padded bits is equal to a first difference between the second size and the first size, or a number of truncated bits is equal to a second difference between the first size and the second size.

5-6. (canceled)

7. The method according to claim 4, wherein the downlink control information comprises at least one information field.

8. The method according to claim 7, wherein the truncated bit comprises at least one of the following:
at least one most significant bit in the at least one information field;
at least one least significant bit in the at least one information field; or
a bit other than a bit configured to indicate a type of the information field in the at least one information field.

9. The method according to claim 7, wherein the at least one information field belongs to the same type, and different information fields in the at least one information field indicate information of different scheduled cells respectively.

10. The method according to claim 9, wherein determining that the bit in the received downlink control information is truncated comprises:
determining that a bit in each information field is truncated, wherein a number of truncated bits in each information field is equal to a first truncation number, and the first truncation number is determined according to the second difference and a first number; or
wherein determining that the bit in the received downlink control information is truncated comprises:
determining that a bit in n−m information fields of n information fields is truncated; and
determining that a bit in one information field other than the n−m information fields is truncated, wherein a number of at least one information field is n;
a second truncation number of truncated bits in each information field of the n−m information fields is determined according to the second difference and n−m, and a third truncation number of truncated bits in the one information field is equal to max (K−┌K/n┐(n−m),0), wherein K is the second difference.

11. (canceled)

12. The method according to claim 7, wherein the at least one information field comprises a plurality of types of information fields, or an information field configured to indicate a plurality of types of information.

13. The method according to claim 12, wherein determining that the bit in the received downlink control information is truncated comprises:
determining at least one type to be truncated from the plurality of types;
determining a fourth truncation number of bits to be truncated corresponding to each type to be truncated;
determining an information field to be truncated from an information field of each type to be truncated;
determining a fifth truncation number of bits to be truncated in each information field to be truncated, according to the fourth truncation number and a number of information fields to be truncated; and
determining that a bit in each information field to be truncated is truncated according to the fifth truncation number; or
wherein determining that the bit in the received downlink control information is truncated comprises:
determining at least one type of information to be truncated from the plurality of types of information; determining a sixth truncation number of bits to be truncated corresponding to each type of information to be truncated;
determining an information field to be truncated from an information field corresponding to each type of information to be truncated;
determining a seventh truncation number of bits to be truncated in each information field to be truncated, according to the sixth truncation number and a number of information fields to be truncated; and
determining that a bit in each information field to be truncated is truncated according to the seventh truncation number.

14-15. (canceled)

16. A method for processing downlink control information, performed by a network device, comprising:
determining a first size of the downlink control information, according to a size of an information field in downlink control information configured for scheduling a plurality of cells;
sending indication information to a terminal, wherein the indication information is configured to indicate a second size of the downlink control information sent to the terminal; and
processing the downlink control information sent to the terminal, according to a relationship between the first size and the second size, wherein a size of the processed downlink control information is equal to the second size.

17. (canceled)

18. The method according to claim 16, wherein processing the downlink control information sent to the terminal, according to the relationship between the first size and the second size comprises:
performing zero padding on a bit in the downlink control information sent to the terminal, in a case where the first size is less than the second size; or
truncating a bit in the downlink control information sent to the terminal, in a case where the first size is greater than the second size.

19. The method according to claim 18, wherein a number of zero-padded bits is equal to a first difference between the second size and the first size; or a number of truncated bits is equal to a second difference between the first size and the second size.

20-21. (canceled)

22. The method according to claim 19, wherein the downlink control information comprises at least one information field.

23. (canceled)

24. The method according to claim 22, wherein the at least one information field belongs to the same type, and different information fields in the at least one information field indicate information of different scheduled cells respectively.

25. The method according to claim 24, wherein truncating the bit in the downlink control information sent to the terminal comprises:
truncating a bit in each information field, wherein a number of truncated bits in each information field is equal to a first truncation number, and the first truncation number is determined according to the second difference and a first number; or
wherein truncating the bit in the downlink control information sent to the terminal comprises:
truncating a bit in n−m information fields of n information fields;
truncating a bit in one information field other than the n−m information fields, wherein a number of at least one information field is n;
a second truncation number of truncated bits in each information field of the n−m information fields is determined according to the second difference and n−m, and a third truncation number of truncated bits in the one information field is equal to max (K−┌K/n┐(n−m),0), wherein K is the second difference.

26. (canceled)

27. The method according to claim 22, wherein the at least one information field comprises a plurality of types of information fields, or an information field configured to indicate a plurality of types of information.

28. The method according to claim 27, wherein truncating the bit in the downlink control information sent to the terminal comprises:
determining at least one type to be truncated from the plurality of types;
determining a fourth truncation number of bits to be truncated corresponding to each type to be truncated;
determining an information field to be truncated from an information field of each type to be truncated;
determining a fifth truncation number of bits to be truncated in each information field to be truncated, according to the fourth truncation number and a number of information fields to be truncated; and
truncating a bit in each information field to be truncated according to the fifth truncation number; or
wherein truncating the bit in the downlink control information sent to the terminal comprises:
determining at least one type of information to be truncated from the plurality of types of information; determining a sixth truncation number of bits to be truncated corresponding to each type of information to be truncated;
determining an information field to be truncated from an information field corresponding to each type of information to be truncated;
determining a seventh truncation number of bits to be truncated in each information field to be truncated, according to the sixth truncation number and a number of information fields to be truncated; and
truncating a bit in each information field to be truncated according to the seventh truncation number.

29-33. (canceled)

34. A communication device, comprising:
one or more processors; and
a memory that stores a computer program, wherein
the computer program, when collectively executed by the one or more processors, causes the communication device to:
determine a first size of the downlink control information, according to a size of an information field in downlink control information configured for scheduling a plurality of cells;
determine a second size of received downlink control information according to indication information; and
perform blind detection on the received downlink control information, according to a relationship between the first size and the second size, wherein a size of the downlink control information for the blind detection is equal to the second size.

35. (canceled)

36. A non-transitory computer-readable storage medium storing a computer program, wherein the computer program, when collectively executed by one or more processors, causes the one or more processors to perform the blind detection method for the downlink control information according to claim 1.

37. (canceled)
